(19) United States
(12) Patent Application Publication
(10) Pub. No.: US 2021/0095229 A1
(43) Pub. Date: Apr. 1, 2021

(54) FABRIC CARE COMPOSITIONS THAT INCLUDE A COPOLYMER AND RELATED METHODS

(71) Applicant: The Procter & Gamble Company, Cincinnati, OH (US)

(72) Inventors: Renae Dianna FOSSUM, Middletown, OH (US); Neil Joseph LANT, Newcastle upon Tyne (GB); Samantha Jo COST, Cincinnati, OH (US); Lidiany GONZALEZ, West Chester, OH (US); Paul David THORNTON, Leeds (GB); Saskia Jane BOARDMAN, Leeds (GB); Adam Simon HAYWARD, Durham (GB)

(21) Appl. No.: 17/017,727

(22) Filed: Sep. 11, 2020

(30) Foreign Application Priority Data
Sep. 30, 2019 (EP) 19200479.4

(51) Int. Cl. C11D 3/37; C11D 3/386; C11D 3/00; C11D 1/83; C11D 11/00; C11D 17/04

(52) U.S. Cl. CPC C11D 3/3715; C11D 3/3788; C11D 3/38645; C11D 3/38636; C11D 17/044; C11D 1/83; C11D 11/0017; C11D 17/043; C11D 3/0021

(57) ABSTRACT

Fabric care compositions that include a linear copolymer. Methods and uses relating to such compositions and/or graft copolymers.

### FIELD OF THE INVENTION

The present disclosure relates to compositions, such as fabric care compositions, that include a polyester copolymer in combination with an enzyme. The present disclosure also relates to methods and uses relating to such compositions and/or polyester copolymers.

### BACKGROUND OF THE INVENTION

When laundering fabrics, dye transfer can cause challenges. For example, dye from one portion of a fabric may become released in a wash liquor and may then deposit on a different portion of the fabric, or on a different fabric altogether. Transfer of such dyes (known as “fugitive dyes”) can cause greying of fabrics, especially of those of a light or white color. Cotton, poly/cotton, and nylon fabrics are particularly good acceptor fabrics for fugitive dye, and over multiple wash cycles, fugitive dye re-deposition results in bright and lightly colored clothes appearing dull or faded over time. This problem is particularly difficult to solve in the consumer home since typical wash loads contain mixed fabric types and colors that will have multiple sources of fugitive dyes that can be soluble in the wash liquor (eg. direct dyes, hydrolyzed reactive dyes), or insoluble in the wash liquor (eg. particulate or vat dyes).

Denim, such as jeans, are often included in mixed colored wash loads. Denim jeans are typically made from twill cotton fabric with warp threads that are dyed and woven with undyed weft threads that are white. The warp threads are ring dyed typically with indigo, or sulfur black 1, or mixtures thereof. Dye loss from jeans can cause particularly problematic dye transfer onto other bright and lightly colored items in the load making them appear dull, and less bright. Without wishing to be bound by theory, indigo is a so-called Leuco dye that soluble in the reduced form for dyeing fabrics that oxidizes in air to convert to the insoluble, blue colored dye. Indigo is physically associated with the cotton fibers, and indigo can be released during the wash process and re-deposit on other fabrics in the wash load during washing. Depending on how the garment was treated by the manufacturer, indigo can be released over multiple wash cycles. Thus, there remains a problem of indigo dye transfer during the wash.

Certain polymers, generally known as dye transfer inhibitor (“DTI”) polymers, have traditionally been used in laundry compositions to address the dye transfer problem. Such polymers include polyvinyl pyrrolidone (PVP), poly(vinylpyridine-N-oxide) (PVNO), polyvinylpyrrolidone-co-polyvinylimidazole (PVP/PVI), and poly(vinylpyrrolidone)co-poly(vinylpyridine-N-oxide) (PVP/PVNO) polymers, which have typically included relatively high levels of vinyl pyrrolidone (“VP”). These traditional DTI polymers are quite effective at inhibiting the transfer of direct dyes, which are dyes that are used to dye cellulosic fibers that are known to have poor wash fastness resulting in dye bleeding during the wash process.

It is believed that the traditional DTI polymers are not effective on vat dyes such as indigo. Additionally or alternatively, traditional DTI polymers can lead to stability challenges in combination with other laundry adjuncts, such as optical brighteners. Thus, particularly as direct dyes have become less prevalent in typical laundry loads, traditional DTI polymers are only effective on a small portion of the garments in the wash load, and consumers continue to have a problem with dye transfer even with detergents that contain traditional DTI polymers. This challenge may be made even more acute by the laundry practices of the modern consumer, including larger loads that tend to have mixed fabric types and colors (e.g., under-sorted loads).

Cellulase enzymes are known to release dye from unwashed denim to give denim an uneven dye appearance, or so-called “worn” look on denim. Consumers typically want to keep this “just purchased” look of their denim, even after washing multiple times. Too high a level of cellulase enzyme in a detergent composition can result in the unintended fading of the garment that may also compound the dye transfer negative that can occur in mixed color loads.

Therefore, there remains a need for improved, stable laundry compositions and related processes that can inhibit dye transfer, particularly transfer of particulate dyes such as indigo while also maintaining the appearance of the jeans.

### SUMMARY OF THE INVENTION

The present disclosure attempts to solve one or more of the aforementioned needed by providing detergent compositions that include particular polyester copolymers at a level of 0.1% to 5% that when combined with a cellulase enzyme that may be useful for dye transfer inhibition (also known as dye control) and to prevent fading, and related processes. The present disclosure further describes a detergent composition that include polyester copolymers at a level of 0.1% to 5% combined with a cellulase enzyme, and a suspension graft copolymer.

### DETAILED DESCRIPTION OF THE INVENTION

Features and benefits of the present invention will become apparent from the following description, which includes examples intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

As used herein the phrases “detergent composition” and “cleaning composition” are used interchangeably and include compositions and formulations designed for cleaning soiled material. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

The term “linear” refers to a straight chain, non-branched hydrocarbon.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All cited patents and other documents are, in relevant part, incorporated by reference as if fully restated herein. The citation of any patent or other document is not an admission that the cited patent or other document is prior art with respect to the present invention.

In this description, all concentrations and ratios are on a weight basis of the detergent composition unless otherwise specified.

### Composition

The compositions of the present disclosure may be fabric care compositions. Such compositions may be used as a pre-laundering treatment, a post-laundering treatment, or may be added during the rinse or wash cycle of the laundering operation.

The composition may be selected from the group of light duty liquid detergents compositions, heavy duty liquid detergent compositions, detergent gels commonly used for laundry, bleaching compositions, laundry additives, fabric enhancer compositions, and mixtures thereof. The composition may be a heavy duty liquid detergent composition.

The composition may be in any suitable form. The composition may be in the form of a liquid composition, a granular composition, a single-compartment pouch, a multi-compartment pouch, a sheet, a pastille or bead, a fibrous article, a tablet, a bar, flake, or a mixture thereof. The composition can be selected from a liquid, solid, or combination thereof.

As used herein, “liquid” includes free-flowing liquids, as well as pastes, gels, foams and mousses. Non-limiting examples of liquids include light duty and heavy duty liquid detergent compositions, fabric enhancers, detergent gels commonly used for laundry, bleach and laundry additives. Gases, e.g., suspended bubbles, or solids, e.g. particles, may be included within the liquids. A “solid” as used herein includes, but is not limited to, powders, agglomerates, and mixtures thereof. Non-limiting examples of solids include: granules, micro-capsules, beads, noodles, and pearlised balls.

The cleaning composition may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof.

The compositions of the present disclosure may include a graft copolymer and one or more treatment adjuncts, as described in more detail below.

### Polyester Copolymers

The compositions of the present disclosure may include a copolymer. Suitable copolymers typically have hydrophilic segments and hydrophobic segments and may be nonionic (e.g., comprising only nonionic monomer units and/or no anionic or cationic units). A nonionic copolymer may be particularly preferred when the copolymer is used in a liquid detergent composition, in order to avoid potentially negative interactions that cause product instability.

The structure of the copolymer agent may be linear, branched, or star-shaped.

According to the present invention, the copolymer is a polyester, which can be produced by reaction, preferably esterification, of at least the following monomers:

(A) one or more dicarboxylic acid compound(s),

(B) one or more diol compound(s) having from 2 to 6 carbon atoms, and

(C) polyalkylene oxides with one or two hydroxy groups or one hydroxy group and one methoxy group having at least 6 oxygen atoms; and

(D) a polyol compound with 3 or more reactive groups wherein the reactive groups may be hydroxyl groups or amine groups.

The term polyalkylene oxide as used herein refers to compounds with one or two hydroxy groups having at least 6 oxygen atoms, preferably at least 10 oxygen atoms, more preferably more than 16 oxygen atoms. The polyalkylene oxide may be terminated with one or two hydroxy groups, or terminated with one hydroxy group and one methoxy group, or terminated with two methoxy groups.

By the term ‘diols’ as used herein is meant compounds having two hydroxyl groups and not more than one ether group, preferably none.

The dicarboxylic acid compound (A) includes aliphatic and/or aromatic dicarboxylic acids and their derivatives, e.g. their monoesters, diesters, anhydrides, or mixtures. The dicarboxylic acid compounds preferably have 3 to 40 carbon atoms, related to the dicarboxylic acid or the dicarboxylic acid group. According to the present invention, the aromatic dicarboxylic acid compounds may especially be terephthalic acid, isophthalic acid, phthalic acid, their mono- and dialkyl esters having C₁- to C₅-alcohols, e.g. dimethyl terephthalate, and mixtures of said compounds. Examples of aliphatic dicarboxylic acid compounds include malonic, succinic, fumaric, maleic, glutaric, adipic, pimelic, suberic, azelaic, and sebacic acid dialkyl esters. It is particularly preferable to use isophthalic acid and phthalic acid, especially terephthalic acid and the dimethyl-, diethyl-, dipropyl-, and dibutyl esters thereof.

The aromatic dicarboxylic acids include terephthalic acid and especially isophthalic acid, phthalic acid, their mono- and dialkyl esters having C₁ to C₅ alcohols, e.g. dimethyl terephthalate, and mixtures of said components. Examples of aliphatic dicarboxylic acid equivalents include malonic, succinic, fumaric, maleic, glutaric, adipic, pimelic, suberic, azelaic, and sebacic acid dialkyl esters.

It is particularly preferable to use terephthalic acid and phthalic acid and the dimethyl-, diethyl-, dipropyl-, and dibutyl esters thereof.

Tricarboxylic acid compounds resulting in heavily branched polymer structures may be employed as well. For example, trimellitic acid or its derivatives, such as anhydrides and esters, are suitable for this purpose, but actually the latter ones cannot be recommended.

According to the present invention, the diol compound (B) may be for example ethylene glycol, 1,2- or 1,3-propylene glycol, neopentyl glycol, 1,2-butylene glycol, 3-methoxy-1,2-propylene glycol, and the dimers and trimers thereof. The diol compound (B) preferably has 2 to 6 carbon atoms. Mixtures of various diols are appropriate as well. It is preferable to use ethylene glycol and/or propylene glycol.

Examples of the polyalkylene oxide (C) include products obtained by the addition of ethylene oxide, propylene oxide, butylene oxide, or mixtures thereof to water or aliphatic C₁ to C₁₈ alcohols, preferably C₁ to C₆ alcohols, such as methanol, ethanol, propanol, or butanol. It is preferable to use addition products of ethylene oxide to methanol or water. Polyalkylene oxides may have a terminal hydroxyl group or terminal methoxy group.

It is preferable to use polyalkylene oxides with mean molecular weights from 500 to 10,000 g/mole and polyethylene glycol monomethyl ethers with molecular weights from 500 to 5,000 g/mole.

The polyol compounds (D) preferably have 3 to 12 carbon atoms. Examples of polyol compounds having at least 3 OH groups include pentaerythritol, trimethylol ethane, trimethylol propane, 1,2,3-hexanetriol, sorbitol, mannitol, mono-, di-, and triglycerol, 1,2,3-butanetriol, 1,2,4-butanetriol. It is preferable that glycerol be used.

Examples of polyol compounds (D) with 3 or more reactive groups wherein the reactive groups may comprise at least one amine group include dimethylolamine, diethanolamine, 4-amino-1,7-heptane diol, 2-amino-2-methyl-1,3-propane diol, N,N-bis(2-hydroxypropyl)amine, tris(hydroxymethyl)aminomethane, tris(hydroxyethyl)aminomethane, polyetheramines for example the Jeffamine D series. Catalysts are typically used to make the polyesters. Typical catalysts such as p-toluene sulfonic acid, Titanium (IV) Isopropoxide, calcium acetate and antimony oxide, organic and inorganic tin- and zinc compounds (e.g. stannanes, zinc acetate, or the TEGO™ catalysts of Degussa), or tetraalkoxy titanates, such as titanium tetraisobutanolate or titanium tetraisopropanolate can be used. The condensation may be carried out in the presence of antioxidants, such as substituted phenols, e.g. 2,5-ditertiary butyl phenol, 2,6-di-tert-butyl-p-cresol 2-methylcyclohexyl-4,6-dimethyl phenol, phosphorous acid, or other customary antioxidants to prevent discoloration of the polyesters due to oxidation during condensation.

Suitable polyesters may include a structure as defined by structural unit (II). This can also include combinations with structural unit (II), such as, for example, a combination of one (I) and (II) or a combination of (II) and (III):

—[(OCHR¹—CHR²)ₐ—O—OC—Ar—CO—]_{d} (I)

—[(OCHR³—X—CHR⁴)_{b}—O—OC—Ar—CO—]ₑ (II)

—[(OCHR⁵—CHR⁶)_{c}—OR⁷]_{f} (III)

wherein:

a, b and c are from 1 to 200;

d, e and f are from 1 to 50;

Ar is a 1,4-substituted phenylene;

X is a bifunctional group containing at least one carbon atom and at least one hydroxyl unit or amine unit;

R¹, R², R³, R⁴, R⁵ and R⁶ are independently selected from H or C₁-C₁₈ n- or iso-alkyl; and

R⁷ is independently selected from H or a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

The polyester according to the invention generally have a number average molecular weight in the range of 700 to 50000 g/mol, preferably 800 to 25000 g/mol, more preferably 1000 to 15000 g/mol, most preferably 1100 to 12000 g/mol.

Without wishing to be bound by theory, it is believed that by carefully selecting the relative amounts and/or molecular weights of the monomers of the block copolymers in accordance with the present disclosure, a fabric care composition that includes such copolymers may provide improved dye control during fabric treatment processes, such as wash or rinse cycles.

Additionally or alternatively, it has been found that fabric care compositions that include copolymers according to the present disclosure in combination with certain treatment adjuncts are surprisingly effective and/or stable.

### Enzyme System

The cleaning compositions of the present disclosure comprise an enzyme system. The enzyme system may be present in the detergent composition at a level of from about 0.0001% to about 5%, or from about 0.001% to about 2%, by weight of the cleaning composition. The enzyme system may comprise one or more cellulase enzymes at level of from about 0.0001% to about 0.1%, or from about 0.002% to about 0.075%, or from about 0.005% to about 0.05% by weight of the cleaning composition. It has been surprisingly found that the combination of a low level cellulase enzyme in combination with the polyester copolymer (hereafter “copolymer”) of the present invention can protect clothing from particulate dye transfer, particularly indigo. Furthermore, combining the cellulase with the polyester can protect garments dyed with particulate dyes from fading.

The enzyme system comprises a plurality of enzymes. The enzymes may be provided individually, or they may be provided as a combination, such as in a premix that contains a plurality of enzymes.

The enzyme system contains cellulase enzymes. The system may further additionally comprise one or more cellulase enzymes. The enzyme system may comprise one or more cellulase enzymes each at a level of from 0.0001% to 2%, or from about 0.001% to about 1%, or from about 0.002% to about 0.1%, or from about 0.005% to about 0.05% pure enzyme by weight of the total composition selected from the group consisting of a xyloglucanase enzyme and any mutations thereof and an endoglucanase (endolase) enzyme and any mutations thereof.

### Cellulases

The consumer products can comprise cellulases of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and 5,691,178. Suitable cellulases include the alkaline or neutral cellulases having colour care benefits. Commercially available cellulases include CELLUZYME®, CAREZYME® and CAREZYME PREMIUM (Novozymes A/S), CLAZINASE®, and PURADAX HA® (Genencor International Inc.), and KAC-500(B)® (Kao Corporation).

The bacterial cleaning cellulase may be a glycosyl hydrolase having enzymatic activity towards amorphous cellulose substrates, wherein the glycosyl hydrolase is selected from GH families 5, 7, 12, 16, 44 or 74. Suitable glycosyl hydrolases may also be selected from the group consisting of: GH family 44 glycosyl hydrolases from Paenibacillus polyxyma (wild-type) such as XYG1006 described in U.S. Pat. No. 7,361,736 or are variants thereof. GH family 12 glycosyl hydrolases from Bacillus licheniformis (wild-type) GH family 5 glycosyl hydrolases from Bacillus agaradhaerens (wild type) or variants thereof; GH family 5 glycosyl hydrolases from Paenibacillus (wild type) such as XYG1034 and XYG 1022 described in U.S. Pat. No. 6,630,340 or variants thereof; GH family 74 glycosyl hydrolases from Jonesia sp. (wild type) such as XYG1020 described in WO 2002/077242 or variants thereof; and GH family 74 glycosyl hydrolases from Trichoderma Reesei (wild type. Suitable bacterial cleaning cellulases are sold under the tradenames Celluclean® and Whitezyme® (Novozymes A/S, Bagsvaerd, Denmark).

In one aspect, the composition may comprise a fungal cleaning cellulase belonging to glycosyl hydrolase family 45 having a molecular weight of from 17 kDa to 30 kDa, for example the endoglucanases sold under the tradename Biotouch® NCD, DCC, DCL and FLX1 (AB Enzymes, Darmstadt, Germany). Additionally, preferred cellulases include the ones covered in WO2016066896.

The enzyme system can comprise other enzymes. Suitable enzymes provide cleaning performance and/or fabric care benefits. Examples of other suitable enzymes include, but are not limited to, hemicellulases, peroxidases, proteases, amylase, other cellulases, pectate lyases, xylanases, lipases, phospholipases, esterases, cutinases, pectinases, keratanases, reductases, oxidases, phenoloxidases, lipoxygenases, ligninases, pullulanases, tannases, pentosanases, malanases, nucleases, β-glucanases, arabinosidases, hyaluronidase, chondroitinase, laccase, and known amylases, or combinations thereof. A preferred enzyme system further comprises a cocktail of conventional detersive enzymes such as protease, lipase, cutinase and/or cellulase in conjunction with amylase. Detersive enzymes are described in greater detail in U.S. Pat. No. 6,579,839.

### Enzyme Stabilizing System

The compositions may optionally comprise from about 0.001% to about 10%, or from about 0.005% to about 8%, or from about 0.01% to about 6%, by weight of the composition, of an enzyme stabilizing system. The enzyme stabilizing system can be any stabilizing system which is compatible with the detersive enzyme. Such a system may be inherently provided by other formulation actives, or be added separately, e.g., by the formulator or by a manufacturer of detergent-ready enzymes. Such stabilizing systems can, for example, comprise calcium ion, boric acid, propylene glycol, diethylene glycol, 2-methyl-1,3-propane diol, glycerol, sorbitol, calcium formate, short chain carboxylic acids, boronic acids, chlorine bleach scavengers and mixtures thereof, and are designed to address different stabilization problems depending on the type and physical form of the detergent composition. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

The detergent composition may further comprise a suspension graft copolymer. Specifically, the enzyme system may further comprise a graft polymer as described below.

### Suspension Graft Copolymer

The compositions and methods of the present disclosure relate to a suspension graft polymer. Broadly, the graft polymer may comprise and/or be obtainable by grafting either (a) a polyalkylene oxide with (b)N-vinylpyrrolidone and (c) a vinyl ester or by grafting (a) a polyalklyene oxide with (b) a vinyl ester. The graft polymer is described in more detail below.

Compositions according to the present disclosure may include from about 0.1% to about 50%, or to about 40%, or to about 25%, or from about 0.1% to about 15%, or from about 0.1% to about 10%, or from about 0.2% to about 5%, or from about 0.5% to about 7% by weight of the composition, of the graft polymer. The graft polymer may be present in an aqueous treatment liquor, such as a wash liquor or a rinse liquor of an automatic washing machine, in an amount of about 5 ppm, or from about 10 ppm, or from about 25 ppm, or from about 50 ppm, to about 1500 ppm, or to about 1000 ppm, or to about 500 ppm, or to about 250 ppm.

The graft polymer may be comprise and/or be obtainable by grafting (a) a polyalkylene oxide which has a number average molecular weight of from about 1000 to about 20,000, or to about 15,000, or to about 12,000, or to about 10,000 Daltons and is based on ethylene oxide, propylene oxide, or butylene oxide, preferably based on ethylene oxide, with (b)N-vinylpyrrolidone, and further with (c) a vinyl ester derived from a saturated monocarboxylic acid containing from 1 to 6 carbon atoms and/or a methyl or ethyl ester of acrylic or methacrylic acid, preferably a vinyl ester that is vinyl acetate or a derivative thereof; where the weight ratio of (a):(b) is from about 1:0.1 to about 1:1; where the amount, by weight, of (a) is greater than the amount of (c); and where the order of the addition of monomers (b) and (c) in the graft polymerization is immaterial.

The graft polymer may comprise and/or be obtainable by grafting (a) an alkylene oxide which has a number average molecular weight of from about 1000 to 20,000, or to about 15,000, or to about 12,000, or to about 10,000 Daltons, the alkylene oxide being based on ethylene oxide, with (b)N-vinylpyrrolidone, and (c) vinyl acetate or a derivative thereof; wherein the weight ratio of (a):(b) is from about 1:0.1 to about 1:2, or to about 1:1; wherein the weight ratio of (b):(c) is from about 1:0.1 to about 1:5, or to about 1:4; wherein the weight ratio of (a):(c) is from about 1:0.1 to about 1:5, or to about 1:3; the order of the addition of monomers (b) and (c) in the graft polymerization being immaterial.

The graft polymer may be obtainable by grafting (a) an alkylene oxide which has a number average molecular weight of from about 1000 to 20,000, or to about 15,000, or to about 12,000, or to about 10,000 Daltons, the alkylene oxide being based on ethylene oxide, with (b) N-vinylpyrrolidone, and (c) vinyl acetate or a derivative thereof, the order of the addition of monomers (b) and (c) in the graft polymerization being immaterial, wherein the number of grafting sites is less than 1 per 50 ethylene oxide groups, wherein the composition is a fabric care composition.

The graft bases used may be the polyalkylene oxides specified above under (a). The polyalkylene oxides of component (a) may have a number average molecular weight of about 300, or from about 1000, or from about 2000, or from about 3,000, to about 20,000, or to about 15,000, or to about 12,000, or to about 10,000, or to about 8,000, or to about 6,000 Daltons (Da). Without wishing to be bound by theory, it is believed that if the molecular weight of component (a) (e.g., polyethylene glycol), is relatively low, there may be a performance decrease in dye transfer inhibition. Additionally or alternatively, when the molecular weight is too high, the polymer may not remain suspended in solution and/or may deposit on treated fabrics.

The polyalkylene oxides may be based on ethylene oxide, propylene oxide, butylene oxides, or mixtures thereof, preferably ethylene oxide. The polyalkylene oxides may be based on homopolymers of ethylene oxide or ethylene oxide copolymers having an ethylene oxide content of from about 40 to about 99 mole %. Suitable comonomers for such copolymers may include propylene oxide, n-butylene oxide, and/or isobutylene oxide. Suitable copolymers may include copolymers of ethylene oxide and propylene oxide, copolymers of ethylene oxide and butylene oxide, and/or copolymers of ethylene oxide, propylene oxide, and at least one butylene oxide. The copolymers may include an ethylene oxide content of from about 40 to about 99 mole %, a propylene oxide content of from about 1 to about 60 mole %, and a butylene oxide content of from about 1 to about 30 mole %. The graft base may be linear (straight-chain) or branched, for example a branched homopolymer and/or a branched copolymer.

Branched copolymers may be prepared by addition of ethylene oxide with or without propylene oxides and/or butylene oxides onto polyhydric low molecular weight alcohols, for example trimethylol propane, pentoses, or hexoses. The alkylene oxide unit may be randomly distributed in the polymer or be present therein as blocks.

The polyalkylene oxides of component (a) may be the corresponding polyalkylene glycols in free form, i.e, with OH end groups, or they may be capped at one or both end groups. Suitable end groups may be, for example, C1-C25-alkyl, phenyl, and C1-C14-alkylphenyl groups. The end group may be a C1-alkyl (e.g., methyl) group. Suitable materials for the graft base may include PEG 300, PEG 1000, PEG 2000, PEG 4000, PEG 6000, PEG 8000, and/or PEG 10,000 which are polyethylene glycols, and/or MPEG 2000, MPEG 4000, MPEG 6000, MPEG 8000 and MEG 10000 which are monomethoxypolyethylene glycols that are commercially available from BASF under the tradename Pluriol®.

The polyalkylene oxides may be grafted with N-vinylpyrrolidone as the monomer of component (b). Without wishing to be bound by theory, it is believed that the presence of the N-vinylpyrrolidone (“VP”) monomer in the graft polymers according to the present disclosure provides water-solubility and good film-forming properties compared to otherwise-similar polymers that do not contain the VP monomer. The vinyl pyrrolidone repeat unit has amphiphilic character with a polar amide group that can form a dipole, and a non-polar portion with the methylene groups in the backbone and the ring, making it hydrophobic. When the vinyl pyrrolidone content is too high, there may be negative interactions with other ingredients in the detergent such as brightener causing physical instability, and material cost is high with high vinyl pyrrolidone content.

The polyalkylene oxides may be grafted with a vinyl ester as the monomer of component (c). The vinyl ester may be derived from a saturated monocarboxylic acid, which may contain 1 to 6 carbon atoms, or from 1 to 3 carbon atoms, or from 1 to 2 carbon atoms, or 1 carbon atom. The vinyl ester may be derived from methyl acrylate, ethyl acrylate, methyl methacrylate, ethyl methacrylate, or mixtures thereof. Suitable vinyl esters may include vinyl formate, vinyl acetate, vinyl propionate, vinyl butyrate, vinyl valerate, vinyl iso-valerate, vinyl caproate, or mixtures thereof. Preferred monomers of component (c) include vinyl acetate, vinyl propionate, methyl acrylate, mixtures of vinyl acetate and methyl acrylate, or mixtures thereof, preferably vinyl acetate. The monomers of the graft polymer, e.g., components (a), (b), and/or (c), may be present in certain ratios, such as weight ratios and/or mole ratios.

For example, the weight ratio of (a):(b) may be from about 1:0.1 to about 1:1, or from about 1:0.2 to about 1:0.7. The weight ratio of (a):(b) may be from about 1:0.1 to about 1:2, or to about 1:1. When the VP ratio is too high, the polymer may form negative interactions with other detergent ingredients such as brightener, and/or may not work sufficiently on some hydrolyzed reactive dyes.

The weight ratio of (a):(c) may be greater than 1:1, or from about 1:0.1 to about 1:0.8, or from about 1:0.2 to about 1:0.6. The weight ratio of (a):(c) is from about 1:0.1 to about 1:5, or to about 1:3. The amount, by weight, of (a) may be greater than the amount of (c). Without wishing to be bound by theory, it is believed that relatively high levels of component (c) (e.g., vinyl acetate), particularly in relation to component (a), may result in decreased performance of dye transfer inhibition and/or relatively greater hydrophobicity, which can lead to formulation and/or stability challenges.

The weight ratio of (b):(c) may be from about 1:0.1 to about 1:5, or to about 1:4. Without wishing to be bound by theory, a ratio of VP-to-VAc that is too high may lead to treated fabric having a negative feel. Additionally, negative interactions with ingredients such as brighteners may occur.

The graft polymers of the present disclosure may be characterized by relatively low degree of branching (i.e., degree of grafting). In the graft polymers of the present disclosure, the average number of grafting sites may be less than or equal to 1, or less than or equal to 0.8, or less than or equal to 0.6, or less than or equal to 0.5, or less than or equal to 0.4, per 50 alkylene oxide groups, e.g., ethylene oxide groups. The graft polymers may comprise, on average, based on the reaction mixture obtained, at least 0.05, or at least 0.1, graft site per 50 alkylene oxide groups, e.g., ethylene oxide groups. The degree of branching may be determined, for example, by means of ¹³C NMR spectroscopy from the integrals of the signals of the graft sites and the —CH₂-groups of the polyakylene oxide. The number of grafting sites may be adjusted by manipulating the temperature and/or the feed rate of the monomers. For example, the polymerization may be carried out in such a way that an excess of component (a) and the formed graft polymer is constantly present in the reactor. For example, the quantitative molar ratio of component (a) and polymer to ungrafted monomer (and initiator, if any) is generally greater than or equal to about 10:1, or to about 15:1, or to about 20:1.

The graft polymers of the present disclosure may be characterized by a relatively narrow molar mass distribution. For example, the graft polymers may be characterized by a polydispersity M_{w}/Mₙ of less than or equal to about 3, or less than or equal to about 2.5, or less than or equal to about 2.3. The polydispersity of the graft polymers may be from about 1.5 to about 2.2. The polydispersity may be determined by gel permeation chromatography using narrow-distribution polymethyl methacrylates as the standard.

The graft polymers may be prepared by grafting the suitable polyalkylene oxides of component (a) with the monomers of component (b) in the presence of free radical initiators and/or by the action of high-energy radiation, which may include the action of high-energy electrons. This may be done, for example, by dissolving the polyalkylene oxide in at least one monomer of group (b), adding a polymerization initiator and polymerizing the mixture to completion. The graft polymerization may also be carried out semicontinuously by first introducing a portion, for example 10%, of the mixture of polyalkylene oxide to be polymerized, at least one monomer of group (b) and/or (c) and initiator, heating to polymerization temperature and, after the polymerization has started, adding the remainder of the mixture to be polymerized at a rate commensurate with the rate of polymerization. The graft polymers may also be obtained by introducing the polyalkylene oxides of group (a) into a reactor, heating to the polymerization temperature, and adding at least one monomer of group (b) and/or (c) and polymerization initiator, either all at once, a little at a time, or uninterruptedly, preferably uninterruptedly, and polymerizing.

In the preparation of the graft polymers, the order in which the monomers (b) and (c) are grafted onto component (a) may be immaterial and/or freely chooseable. For example, first N-vinylpyrrolidone may be grafted onto component (a), and then a monomer (c) or a mixture of monomers of group (c). It is also possible to first graft the monomers of group (c) and then N-vinylpyrrolidone onto the graft base (a). It may be that a monomer mixture of (b) and (c) are grafted onto graft base (a) in one step. The graft polymer may be prepared by providing graft base (a) and then first grafting N-vinylpyrrolidone and then vinyl acetate onto the graft base.

Any suitable polymerization initiator(s) may be used, which may include organic peroxides such as diacetyl peroxide, dibenzoyl peroxide, succinyl peroxide, di-tert-butyl peroxide, tert-butyl perbenzoate, tert-butyl perpivalate, tert-butyl permaleate, cumene hydroperoxide, diisopropyl peroxodicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl peracetate, di-tert-amyl peroxide, tert-butyl hydroperoxide, mixtures thereof, redox initiators, and/or azo starters. The choice of initiator may be related to the choice of polymerization temperature.

The graft polymerization may take place at from about 50° C. to about 200° C., or from about 70° C. to about 140° C. The graft polymerization may typically be carried out under atmospheric pressure, but may also be carried out under reduced or superatmospheric pressure.

The graft polymerization may be carried out in a solvent. Suitable solvents may include: monohydric alcohols, such as ethanol, propanols, and/or butanols; polyhydric alcohols, such as ethylene glycol and/or propylene glycol; alkylene glycol ethers, such as ethylene glycol monomethyl and -ethyl ether and/or propylene glycol monomethyl and -ethyl ether; polyalkylene glycols, such as di- or tri-ethylene glycol and/or di- or tri-propylene glycol; polyalkylene glycol monoethers, such as poly(C2-C3-alkylene)glycol mono (C1-C16-alkyl)ethers having 3-20 alkylene glycol units; carboxylic esters, such as ethyl acetate and ethyl propionate; aliphatic ketones, such as acetone and/or cyclohexanone; cyclic ethers, such as tetrahydrofuran and/or dioxane; or mixtures thereof.

The graft polymerization may also be carried out in water as solvent. In such cases, the first step may be to introduce a solution which, depending on the amount of added monomers of component (b) is more or less soluble in water. To transfer water-insoluble products that can form during the polymerization into solution, it is possible, for example, to add organic solvents, for example monohydric alcohols having 1 to 3 carbon atoms, acetone, and/or dimethylformamide. In a graft polymerization process in water, it is also possible to transfer the water-insoluble graft polymers into a finely divided dispersion by adding customary emulsifiers or protective colloids, for example polyvinyl alcohol. The emulsifiers used may be ionic or nonionic surfactants whose HLB value is from about 3 to about 13. HLB value is determined according to the method described in the paper by W. C. Griffin in J. Soc. Cosmet. Chem. 5 (1954), 249.

The amount of surfactant used in the graft polymerization process may be from about 0.1 to about 5% by weight of the graft polymer. If water is used as the solvent, solutions or dispersions of graft polymers may be obtained. If solutions of graft polymers are prepared in an organic solvent or in mixtures of an organic solvent and water, the amount of organic solvent or solvent mixture used per 100 parts by weight of the graft polymer may be from about 5 to about 200, preferably from about 10 to about 100, parts by weight.

The graft polymers may have a K value of from about 5 to about 200, preferably from about 5 to about 50, determined according to H. Fikentscher in 2% strength by weight solution in dimethylformamide at 25 C.

After the graft polymerization, the graft polymer may optionally be subjected to a partial hydrolysis. The graft polymer may include up to 60 mole %, or up to 50 mole %, or up to 40 mole %, or up to 25 mole %, or up to 20 mole %, or up to 15 mole %, or up to 10 mole %, of the grafted-on monomers of component (c) are hydrolyzed. For instance, the hydrolysis of graft polymers prepared using vinyl acetate or vinyl propionate as component (c) gives graft polymers containing vinyl alcohol units. The hydrolysis may be carried out, for example, by adding a base, such as sodium hydroxide solution or potassium hydroxide solution, or alternatively by adding acids and if necessary heating the mixture. Without wishing to be bound by theory, it is believed that increasing the level of hydrolysis of component (c) increases the relative hydrophilicity of the graft polymer.

A suitable amphilic graft co-polymer is Sokalan® HP22, supplied from BASF. Suitable polymers include random graft copolymers, preferably a polyvinyl acetate grafted polyethylene oxide copolymer having a polyethylene oxide backbone and multiple polyvinyl acetate side chains. The molecular weight of the polyethylene oxide backbone is typically about 6000 and the weight ratio of the polyethylene oxide to polyvinyl acetate is about 40 to 60 and no more than 1 grafting point per 50 ethylene oxide units.

### Treatment Adjuncts

The compositions of the present disclosure may include a treatment adjunct. The treatment adjuncts may be suitable for delivering a treatment benefit to a target surface, such as a fabric or other textile. Treatment adjuncts, as used herein, may also include agents that facilitate chemical or physical stability in the treatment compositions, such as buffers, structurants/thickeners, and/or carriers.

The treatment adjunct(s) may be present in the composition at levels suitable for the intended use of the composition. Typical usage levels range from as low as 0.001% by weight of composition for adjuncts such as optical brighteners to 50% by weight of composition for builders.

The treatment adjunct may include a surfactant system, fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, amphiphilic copolymers (including those that are free of vinyl pyrrolidone), brighteners, suds suppressors, dyes, hueing agents, perfume, structure elasticizing agents, fabric softeners, carriers, fillers, hydrotropes, solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof.

The treatment adjunct may include a surfactant system, an optical brightener, a hueing agent, an alkoxylated polyalkyleneimine polymer, an amphiphilic polymer, a traditional DTI polymer, an external structuring system, or combinations thereof. The treatment adjunct may include an encapsulated benefit agent, which may be encapsulated perfume, preferably where the encapsulated perfume comprises a shell surrounding a core, preferably where the shell is comprises amine compounds and/or acrylate polymers.

Several treatment adjuncts are discussed in more detail below.

### Surfactant System

Compositions according to the present disclosure may include a surfactant system. The surfactant system may consist of one type of surfactant. The surfactant system may include more than one surfactant.

The compositions of the present disclosure may include from about from about 1% to about 70%, or from about 2% to about 60%, or from about 5% to about 50%, by weight of the composition, of a surfactant system. Liquid compositions may include from about 5% to about 40%, by weight of the composition, of a surfactant system. Compact formulations, including compact liquids, gels, and/or compositions suitable for a unit dose form, may include from about 25% to about 70%, or from about 30% to about 50%, by weight of the composition, of a surfactant system.

The surfactant system may include anionic surfactant, nonionic surfactant, zwitterionic surfactant, cationic surfactant, amphoteric surfactant, or combinations thereof. The surfactant system may include linear alkyl benzene sulfonate, alkyl ethoxylated sulfate, alkyl sulfate, nonionic surfactant such as ethoxylated alcohol, amine oxide, or mixtures thereof. The surfactants may be, at least in part, derived from natural sources, such as natural feedstock alcohols.

Suitable anionic surfactants may include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. The anionic surfactants may be linear, branched, or combinations thereof. Preferred surfactants include linear alkyl benzene sulfonate (LAS), alkyl ethoxylated sulfate (AES), alkyl sulfates (AS), or mixtures thereof. Other suitable anionic surfactants include branched modified alkyl benzene sulfonates (MLAS), methyl ester sulfonates (IVIES), and/or alkyl ethoxylated carboxylates (AEC). The anionic surfactants may be present in acid form, salt form, or mixtures thereof. The anionic surfactants may be neutralized, in part or in whole, for example, by an alkali metal (e.g., sodium) or an amine (e.g., monoethanolamine).

The surfactant system may include nonionic surfactant. Suitable nonionic surfactants include alkoxylated fatty alcohols, such as ethoxylated fatty alcohols. Other suitable nonionic surfactants include alkoxylated alkyl phenols, alkyl phenol condensates, mid-chain branched alcohols, mid-chain branched alkyl alkoxylates, alkylpolysaccharides (e.g., alkylpolyglycosides), polyhydroxy fatty acid amides, ether capped poly(oxyalkylated) alcohol surfactants, and mixtures thereof. The alkoxylate units may be ethyleneoxy units, propyleneoxy units, or mixtures thereof. The nonionic surfactants may be linear, branched (e.g., mid-chain branched), or a combination thereof. Specific nonionic surfactants may include alcohols having an average of from about 12 to about 16 carbons, and an average of from about 3 to about 9 ethoxy groups, such as C12-C14 EO7 nonionic surfactant.

Suitable zwitterionic surfactants may include any conventional zwitterionic surfactant, such as betaines, including alkyl dimethyl betaine and cocodimethyl amidopropyl betaine, C₈ to C₁₈ (for example from C₁₂ to C₁₈) amine oxides (e.g., C₁₂₋₁₄ dimethyl amine oxide), and/or sulfo and hydroxy betaines, such as N-alkyl-N,N-dimethylamino-1-propane sulfonate where the alkyl group can be C₈ to C₁₈, or from C₁₀ to C₁₄. The zwitterionic surfactant may include amine oxide.

The compositions may comprise a builder. Compositions typically comprise at least about 1% builder, based on the total weight of the composition. Liquid detergent compositions may comprise up to about 10% builder, and in some examples up to about 8% builder, of the total weight of the composition.

Suitable builders include aluminosilicates (e.g., zeolite builders, such as zeolite A, zeolite P, and zeolite MAP), silicates, phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Alternatively, the composition may be substantially free of builder.

### Other Treatment Adjuncts

The compositions of the present disclosure may include an optical brightener. Brighteners, also sometimes referred to as fluorescent whitening agents, may emit at least some visible light.

Commercial optical brighteners, which may be used herein, can be classified into subgroups, which include, but are not necessarily limited to, derivatives of stilbene, pyrazoline, coumarin, carboxylic acid, methinecyanines, dibenzothiphene-5,5-dioxide, azoles, 5- and 6-membered-ring heterocycles, and other miscellaneous agents. The brighteners may be added in particulate form or as a premix with a suitable solvent, for example nonionic surfactant, monoethanolamine, and/or propane diol.

Suitable fluorescent brighteners may include: disodium 4,4′-bis{[4-anilino-6-morpholino-s-triazin-2-yl]-amino}-2,2′-stilbenedisulfonate (Brightener 15, commercially available under the tradename Tinopal AMS-GX by Ciba Geigy Corporation); disodium 4,4′-bis{[4-anilino-6-(N-2-bis-hydroxyethyl)-s-triazine-2-yl]-amino}-2,2′-stilbenedisulonate (commercially available under the tradename Tinopal UNPA-GX by Ciba-Geigy Corporation); disodium 4,4′-bis{[4-anilino-6-(N-2-hydroxyethyl-N-methylamino)-s-triazine-2-yl]-amino}-2,2′-stilbenedisulfonate (commercially available under the tradename Tinopal 5BM-GX by Ciba-Geigy Corporation); and/or disodium 4,4′-bis((4-amino-6-anilino-1,3,5-triazin-2-yl)amino)stilbene-2,2′-disulphonate (Brightener 49). The brightener may be Brightener 49, Brightener 15, or mixtures thereof.

The treatment compositions of the present disclosure may include one or more enzymes that provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, B-glucanases, arabinosidases, hyaluronidase, chondroitinase, laccase, and amylases, or mixtures thereof. Particularly preferred may be a mixture of protease, amylase, lipase, cellulase, and/or pectate lyase.

In particular, it has been found that the present graft polymer in combination with particular enzymes, namely cellulase, can provide surprising benefits on certain fabric materials, which may have been treated by the fabric manufacturer. Suitable cellulases may include xyloglucanase and endolase. Proteases may also be included. Suitable proteases may include metalloproteases and serine proteases, such as including neutral or alkaline microbial serine proteases, such as subtilisins (EC 3.4.21.62). The protease may be a trypsin-type or chymotrypsin-type protease. The protease may be of microbial origin, such as of bacterial origin or of fungal origin. The protease may be a chemically or genetically modified mutant or variant of a wild type.

The compositions of the present disclosure may include a hueing agent. It has surprisingly been found that graft polymers according to the present disclosure may inhibit transfer of fugitive dyes, while having little effect on the deposition and/or performance of hueing agents on target fabrics.

Hueing agents (sometimes referred to as hueing dyes, fabric shading dyes, or bluing or whitening agents) typically provides a blue or violet shade to fabric. Such agent(s) are well known in the art and may be used either alone or in combination to create a specific shade of hueing and/or to shade different fabric types. The hueing agent may be selected from any suitable chemical class of dye as known in the art, including but not limited to acridine, anthraquinone (including polycyclic quinones), azine, azo (e.g., monoazo, disazo, trisazo, tetrakisazo, polyazo), benzodifurane, benzodifuranone, carotenoid, coumarin, cyanine, diazahemicyanine, diphenylmethane, formazan, hemicyanine, indigoids, methane, naphthalimides, naphthoquinone, nitro, nitroso, oxazine, phthalocyanine, pyrazoles, stilbene, styryl, triarylmethane, triphenylmethane, xanthenes and mixtures thereof. The hueing agent may be selected from an azo agent, a triarylmethane agent, a triphenylmethane agent, or mixtures thereof.

Suitable hueing agents include fabric shading dyes such as small molecule dyes, polymeric dyes, and dye-clay conjugates. Preferred fabric shading dyes are selected from small molecule dyes and polymeric dyes. Suitable small molecule dyes may be selected from the group consisting of dyes falling into the Colour Index (C.I., Society of Dyers and Colourists, Bradford, UK) classifications of Acid, Direct, Basic, Reactive, Solvent or Disperse dyes.

Suitable polymeric dyes include dyes selected from the group consisting of polymers containing covalently bound (sometimes referred to as conjugated) chromogens, (also known as dye-polymer conjugates), for example polymers with chromogen monomers co-polymerized into the backbone of the polymer and mixtures thereof. Preferred polymeric dyes comprise the optionally substituted alkoxylated dyes, such as alkoxylated triphenyl-methane polymeric colourants, alkoxylated carbocyclic and alkoxylated heterocyclic azo colourants including alkoxylated thiophene polymeric colourants, and mixtures thereof, such as the fabric-substantive colorants sold under the name of Liquitint® (Milliken, Spartanburg, S.C., USA).

Suitable dye clay conjugates include dye clay conjugates selected from the group comprising at least one cationic/basic dye and a smectite clay; a preferred clay may be selected from the group consisting of Montmorillonite clay, Hectorite clay, Saponite clay and mixtures thereof.

Pigments are well known in the art and may also be used as hueing agents in the fabric care compositions disclosed herein. Suitable pigments may include C.I Pigment Blues 15 to 20, especially 15 and/or 16, C.I. Pigment Blue 29, C.I. Pigment Violet 15, Monastral Blue, and mixtures thereof.

The amount of adjunct hueing agent present in a laundry care composition of the invention may be from 0.0001 to 0.05 wt % based on the total cleaning composition, preferably from 0.0001 to 0.005 wt %. Based on the wash liquor, the concentration of hueing agent may be from 1 ppb to 5 ppm, preferably from 10 ppb to 500 ppb.

The cleaning compositions of the present invention may also include one or more cellulosic polymers including those selected from alkyl cellulose, alkyl alkoxyalkyl cellulose, carboxyalkyl cellulose, alkyl carboxyalkyl cellulose. In one aspect, the cellulosic polymers are selected from the group comprising carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from 100,000 Da to 300,000 Da.

Additional amines may be used in the compositions described herein for added removal of grease and particulates from soiled materials. The compositions described herein may comprise from about 0.1% to about 10%, or from about 0.1% to about 4%, or from about 0.1% to about 2%, by weight of the composition, of additional amines. Non-limiting examples of additional amines include, but are not limited to, polyetheramines, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

Optical brighteners or other brightening or whitening agents may be incorporated at levels of from about 0.01% to about 1.2%, by weight of the composition, into the detergent compositions described herein. Commercial fluorescent brighteners suitable for the present invention can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents. In some examples, the fluorescent brightener is selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by Ciba Geigy Corporation), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by Ciba-Geigy Corporation), disodium 4,4′-Ns{[4-anilino-6-(N-2-hydroxyethyl-N-methylamino)-s-triazine-2-yl]-amino}-2,2′-stilbenedisulfonate (commercially available under the tradename Tinopal 5BM-GX by Ciba-Geigy Corporation). More preferably, the fluorescent brightener is disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, propanediol.

The detergent compositions described herein may also contain one or more metal ion chelating agents. Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins and mixtures thereof. Chelating agents can be present in the acid or salt form including alkali metal, ammonium, and substituted ammonium salts thereof, and mixtures thereof. Other suitable chelating agents for use herein are the commercial DEQUEST series, and chelants from Monsanto, Akzo-Nobel, DuPont, Dow, the Trilon® series from BASF and Nalco.

The chelant may be present in the detergent compositions disclosed herein at from about 0.005% to about 15% by weight, about 0.01% to about 5% by weight, about 0.1% to about 3.0% by weight, or from about 0.2% to about 0.7% by weight, or from about 0.3% to about 0.6% by weight of the detergent compositions disclosed herein.

The compositions of the present disclosure may include an antioxidant. Without wishing to be bound by theory, it is believed that antioxidants may help to improve malodor control and/or cleaning performance of the compositions, particularly in combination with the oligoamines of the present disclosure. Antioxidants may also help to reduce yellowing that may be associated with amines, allowing the amines to be formulated at a relatively higher level. Antioxidants are substances as described in Kirk-Othmer (Vol. 3, page 424) and in Ullmann's Encyclopedia (Vol. 3, page 91).

The compositions of the present disclosure may include an antioxidant, preferably a hindered phenol antioxidant, in an amount of from about 0.001% to about 2%, preferably from about 0.01% to about 0.5%, by weight of the composition.

Suitable antioxidants may include alkylated phenols, having the general formula:

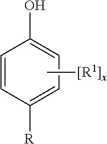

wherein R is C₁-C₂₂ linear alkyl or C₃-C₂₂ branched alkyl, each (1) having optionally therein one or more ester (—CO₂—) or ether (—O—) links, and (2) optionally substituted by an organic group comprising an alkyleneoxy or polyalkyleneoxy group selected from EO (ethoxy), PO (propoxy), BO (butoxy), and mixtures thereof, more preferably from EO alone or from EO/PO mixtures; R may preferably be methyl, branched C₃-C₆ alkyl, or C₁-C₆ alkoxy, preferably methoxy; le is a C₃-C₆ branched alkyl, preferably tert-butyl; x is 1 or 2.

Preferred types of alkylated phenols having this formula may include hindered phenolic compounds. As used herein, the term “hindered phenol” is used to refer to a compound comprising a phenol group with either (a) at least one C₃ or higher branched alkyl, preferably a C₃-C₆ branched alkyl, preferably tert-butyl, attached at a position ortho to at least one phenolic —OH group, or (b) substituents independently selected from the group consisting of a C₁-C₆ alkoxy, preferably methoxy, a C₁-C₂₂ linear alkyl or C₃-C₂₂ branched alkyl, preferably methyl or branched C₃-C₆ alkyl, or mixtures thereof, at each position ortho to at least one phenolic —OH group. If a phenyl ring comprises more than one —OH group, the compound is a hindered phenol provided at least one such —OH group is substituted as described immediately above. Where any R group in the structure above comprises three or more contiguous monomers, that antioxidant is defined herein as a “polymeric hindered phenol antioxidant.” Compositions according to the present disclosure may include a hindered phenol antioxidant. A preferred hindered phenol antioxidant includes 3,5-di-tert-butyl-4-hydroxytoluene (BHT).

A further class of hindered phenol antioxidants that may be suitable for use in the composition is a benzofuran or benzopyran derivative having the formula:

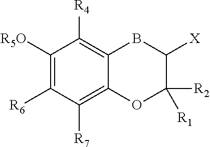

wherein R₁ and R₂ are each independently alkyl or R₁ and R₂ can be taken together to form a C₅-C₆ cyclic hydrocarbyl moiety; B is absent or CH₂; R₄ is C₁-C₆ alkyl; R₅ is hydrogen or —C(O)R₃ wherein R₃ is hydrogen or C₁-C₁₉ alkyl; R₆ is C₁-C₆ alkyl; R₇ is hydrogen or C₁-C₆ alkyl; X is —CH₂OH, or —CH₂A wherein A is a nitrogen-comprising unit, phenyl, or substituted phenyl. Preferred nitrogen-comprising A units include amino, pyrrolidino, piperidino, morpholino, piperazino, and mixtures thereof.

Suitable hindered phenol antioxidants may include: 2,6-bis(1,1-dimethylethyl)-4-methyl-phenol; 3,5-bis(1,1-dimethylethyl)-4-hydroxy-benzenepropanoic acid, methyl ester; 3,5-bis(1,1-dimethylethyl)-4-hydroxybenzenepropanoic acid, octadecyl ester; or mixtures thereof.

Commercially available antioxidants that may be suitable include BHT, RALOX 35™, and/or TINOGARD TS™.

Additional antioxidants may be employed. Examples of suitable antioxidants for use in the composition include, but are not limited to, the group consisting of α-, β-, γ-, δ-tocopherol, ethoxyquin, 2,2,4-trimethyl-1,2-dihydroquinoline, 2,6-di-tert-butyl hydroquinone, tert-butyl hydroxyanisole, lignosulphonic acid and salts thereof, and mixtures thereof. It is noted that ethoxyquin (1,2-dihydro-6-ethoxy-2,2,4-trimethylquinoline) is marketed under the name Raluquin® by the company Raschig™. Other types of antioxidants that may be used in the composition are 6-hydroxy-2,5,7,8-tetramethylchroman-2-carboxylic acid (Trolox™) and 1,2-benzisothiazoline-3-one (Proxel GXL™). Antioxidants such as tocopherol sorbate, butylated hydroxyl benzoic acids and their salts, gallic acid and its alkyl esters, uric acid and its salts, sorbic acid and its salts, and dihydroxyfumaric acid and its salts may also be useful. Other useful antioxidants may include tannins, such as tannins selected from the group consisting of gallotannins, ellagitannins, complex tannins, condensed tannins, and combinations thereof.

The use of non-yellowing antioxidants, such as non-yellowing hindered phenol antioxidants, may be preferred. Antioxidants that form such yellow by-products may be avoided if they lead to perceptible negative attributes in the consumer experience (such as deposition of yellow by-products on fabric, for example). The skilled artisan is able to make informed decisions regarding the selection of antioxidants to employ.

Compositions of the present invention may include and amine. Suitable oligoamines for malodour reduction on fabric may include diethylenetriamine (DETA), 4-methyl diethylenetriamine (4-MeDETA), dipropylenetriamine (DPTA), 5-methyl dipropylenetriamine (5-MeDPTA), triethylenetetraamine (TETA), 4-methyl triethylenetetraamine (4-MeTETA), 4,7-dimethyl triethylenetetraamine (4,7-Me2TETA), 1,1,4,7,7-pentamethyl diethylenetriamine (M5-DETA), tripropylenetetraamine (TPTA), tetraethylenepentaamine (TEPA), tetrapropylenepentaamine (TPPA), pentaethylenehexaamine (PEHA), pentapropylenehexaamine (PPHA), hexaethyleneheptaamine (HEHA), hexapropyleneheptaamine (HPHA), N,N′-Bis(3-aminopropyl)ethylenediamine, or mixtures thereof.

The oligoamine may preferably be selected from diethylenetriamine (DETA), 4-methyl diethylenetriamine (4-MeDETA), 1,1,4,7,7-pentamethyl diethylenetriamine (M5-DETA), dipropylenetriamine (DPTA), 5-methyl dipropylenetriamine (5-MeDPTA), triethylenetetramine (TETA), tripropylenetetraamine (TPTA), tetraethylenepentaamine (TEPA), tetrapropylenepentaamine (TPTA), N,N′-Bis(3-aminopropyl)ethylenediamine, and mixtures thereof, more preferably diethylenetriamine (DETA), 4-methyl diethylenetriamine (4-MeDETA), 1,1,4,7,7-pentamethyl diethylenetriamine (M5-DETA), triethylenetetramine (TETA), tetraethylenepentaamine (TEPA), N,N′-Bis(3-aminopropyl)ethylenediamine, and mixtures thereof, even more preferably diethylenetriamine (DETA), 4-methyl diethylenetriamine (4-MeDETA), N,N′-Bis(3-aminopropyl)ethylenediamine, and mixtures thereof, most preferably diethylenetriamine (DETA). DETA may be preferred due to its low molecular weight and/or relatively low cost to produce.

The compositions of the present disclosure may comprise an alkoxylated polyalkyleneimine polymer, such as an alkoxylated polyethyleneimine (PEI) polymer as described above. Such PEI polymers may facilitate viscosity modification of the compositions. The alkoxylated polyalkylenimine may be present in the composition at a level of from about 0.1% to about 5%, or from about 0.5% to about 4.5%, preferably from about 0.75% to about 1.5%, by weight of the composition. The alkoxylated polyalkyleneimine polymer, preferably alkoxylated PEI, may comprise ethoxylate (EO) groups, propoxylate (PO) groups, or combinations thereof. The alkoxylated polyalkyleneimine polymer, preferably alkoxylated PEI, may comprise ethoxylate (EO) groups. The alkoxylated polyalkyleneimine polymer, preferably alkoxylated PEI, may be free of propoxylate (PO) groups. The alkoxylated polyalkyleneimine polymer, preferably alkoxylated PEI, may comprise on average per alkoxylated nitrogen, about 1-50 ethoxylate (EO) groups and about 0-30 propoxylate (PO) groups. The alkoxylated polyalkylenimine may be linear, branched, or combinations thereof, preferably branched. Suitable alkoxylated polyalkyleneimines, such as PEI600 EO20 and/or PEI600 EO24 PO16, are available from BASF (Ludwigshafen, Germany).

Liquid compositions according to the present disclosure may include an external structurant. It has been found that liquid fabric care compositions that include polyester copolymers and suspension graft polymers according to the present disclosure may not be physically stable; for example, such compositions may separate. It has further been found that external structurants can provide physical stability to liquid compositions according to the present disclosure. External structurants may include non-polymeric crystalline, hydroxy-functional structurants, natural or synthetic polymeric structurants, bacterial cellulose and/or cellulosic fiber structurants.

Non-polymeric crystalline, hydroxyl functional structurants may comprise a crystallizable glyceride, which may be pre-emulsified to aid dispersion into the final detergent composition. Suitable crystallizable glycerides include hydrogenated castor oil or “HCO” or derivatives thereof, provided that it is capable of crystallizing in the liquid detergent composition.

Polymeric structurants may include naturally derived structurants and/or synthetic structurants. Naturally derived polymeric structurants include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. The structurant may comprise cellulosic fibers, for example in the form of microfibrillated cellulose. Cellulose may be derived from bacterial, wood, or other plants such as fruit or sugar beet.

Synthetic polymeric structurants include: polycarboxylates, polyacrylates, hydrophobically modified ethoxylated urethanes, hydrophobically modified non-ionic polyols and mixtures thereof. The polycarboxylate polymer may be a polyacrylate, polymethacrylate or mixtures thereof. The polyacrylate may be a copolymer of unsaturated mono- or di-carbonic acid and C₁-C₃₀ alkyl ester of the (meth)acrylic acid. Such copolymers are available from Lubrizol Corp. under the tradename Carbopol® Aqua 30.

Suitable structurants/thickeners also include bacterial cellulose. The fluid detergent composition may comprise from about 0.005% to about 1% by weight of a bacterial cellulose network. The term “bacterial cellulose” encompasses any type of cellulose produced via fermentation of a bacteria of the genus Acetobacter such as CELLULON® by CPKelco U.S. and includes materials referred to popularly as microfibrillated cellulose, reticulated bacterial cellulose, and the like.

Suitable structurants/thickeners also include coated bacterial cellulose. The bacterial cellulose may be at least partially coated with a polymeric thickener. The at least partially coated bacterial cellulose may comprise from about 0.1% to about 5%, or even from about 0.5% to about 3%, by weight of bacterial cellulose; and from about 10% to about 90% by weight of the polymeric thickener. Suitable bacterial cellulose may include the bacterial cellulose described above and suitable polymeric thickeners include: carboxymethylcellulose, cationic hydroxymethylcellulose, and mixtures thereof.

Suitable structurants/thickeners also include cellulose fibers. The composition may comprise from about 0.01 to about 5% by weight of the composition of a cellulosic fiber. The cellulosic fiber may be extracted from vegetables, fruits or wood. Commercially available examples are Avicel® from FMC, Citri-Fi from Fiberstar or Betafib from Cosun.

The compositions of the present disclosure may include traditional dye transfer inhibitor (DTI) polymers, such as polyvinyl pyrrolidone (PVP), poly(vinylpyrine-N-oxide) (PVNO), polyvinylpyrrolidone-co-polyvinylimidazole (PVP/PVI), poly(vinylpyrrolidone)co-poly(vinylpyridine-N-oxide) (PVP/PVNO), or mixtures thereof. It is believed that formulating with both the copolymer of the present disclosure, which is believed to be effective at controlling hydrolyzed reactive dyes, and traditional DTI polymers, which are believed to be effective at controlling direct dyes, can provide a fabric care composition that provides more effective dye control across the wide spectrum of fabric types and dyes present in modern loads of laundry. Commercially available DTI polymers include Kollidon 90, Reilline 4035, and Sokalan HP 56. The weight ratio of the graft copolymer of the present disclosure to traditional DTI polymer may be from about 1:10 to about 10:1.

The compositions of the present disclosure may include solvent, preferably organic solvent, such as a non-aminofunctional organic solvent. Suitable organic solvents may include glycerol, ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof.

The compositions of the present disclosure may be encapsulated within a water-soluble film, for example, a film comprising polyvinyl alcohol (PVOH).

Other Adjunct Ingredients

A wide variety of other ingredients may be used in the detergent compositions herein, including other active ingredients, carriers, hydrotropes, processing aids, dyes or pigments, solvents for liquid formulations, and solid or other liquid fillers, erythrosine, colliodal silica, waxes, probiotics, surfactin, aminocellulosic polymers, Zinc Ricinoleate, perfume microcapsules, rhamnolipids, sophorolipids, glycopeptides, methyl ester sulfonates, methyl ester ethoxylates, sulfonated estolides, cleavable surfactants, biopolymers, silicones, modified silicones, aminosilicones, deposition aids, locust bean gum, cationic hydroxyethylcellulose polymers, cationic guars, hydrotropes (especially cumenesulfonate salts, toluenesulfonate salts, xylenesulfonate salts, and naphalene salts), antioxidants, BHT, PVA particle-encapsulated dyes or perfumes, pearlescent agents, effervescent agents, color change systems, silicone polyurethanes, opacifiers, tablet disintegrants, biomass fillers, fast-dry silicones, glycol distearate, hydroxyethylcellulose polymers, hydrophobically modified cellulose polymers or hydroxyethylcellulose polymers, starch perfume encapsulates, emulsified oils, bisphenol antioxidants, microfibrous cellulose structurants, properfumes, styrene/acrylate polymers, triazines, soaps, superoxide dismutase, benzophenone protease inhibitors, functionalized TiO2, dibutyl phosphate, silica perfume capsules, and other adjunct ingredients, silicate salts (e.g., sodium silicate, potassium silicate), choline oxidase, pectate lyase, mica, titanium dioxide coated mica, bismuth oxychloride, and other actives.

The compositions described herein may also contain vitamins and amino acids such as: water soluble vitamins and their derivatives, water soluble amino acids and their salts and/or derivatives, water insoluble amino acids viscosity modifiers, dyes, nonvolatile solvents or diluents (water soluble and insoluble), pearlescent aids, foam boosters, additional surfactants or nonionic cosurfactants, pediculocides, pH adjusting agents, perfumes, preservatives, chelants, proteins, skin active agents, sunscreens, UV absorbers, vitamins, niacinamide, caffeine, and minoxidil.

The compositions of the present invention may also contain pigment materials such as nitroso, monoazo, disazo, carotenoid, triphenyl methane, triaryl methane, xanthene, quinoline, oxazine, azine, anthraquinone, indigoid, thionindigoid, quinacridone, phthalocianine, botanical, and natural colors, including water soluble components such as those having C.I. Names. The detergent compositions of the present invention may also contain antimicrobial agents.

It may be desirable to limit or even eliminate certain adjuncts, particularly if a detergent sourced primarily from natural or sustainable sources is desired. The detergent compositions of the present disclosure may be free of silicone, dye, brightener, or combinations thereof. The detergent compositions of the present disclosure may comprise less than 5%, or less than 3%, or less than 1%, by weight of the composition, of amine-containing compounds, with the proviso that amine oxide surfactant (if present) is not included in the total amount of amine-containing compounds.

### Method of Making a Composition

The present disclosure relates to methods of making fabric care compositions comprising the graft copolymers described herein. The method may include combining the components of the compositions described herein in the proportions described. For example, a graft polymer according to the present disclosure may be provided and combined with at least one treatment adjunct to form a fabric care composition.

Liquid compositions according to the present disclosure may be made according to conventional methods, for example in a batch process or in a continuous loop process.

Solid compositions according to the present disclosure may be made according to conventional methods, for example by spray-drying process or in an agglomeration process.

The detergent compositions described herein may be encapsulated in a pouch, preferably a pouch made of water-soluble film, to form a unit dose article that may be used to treat fabrics. It may be preferred that such compositions have relatively low amounts of water, for example less than about 20%, or less than about 15%, or less than about 12%, or less than about 10%, or less than about 8%, by weight of the detergent composition, of water.

### Method of Using Compositions

The present disclosure relates to methods of using the compositions described herein. The detergent compositions may be a fabric care composition and may be used to treat a surface, such as a fabric or other textile.

Methods of treating a surface may include the steps of: providing a surface, preferably a fabric, and contacting the surface with a composition according to the present disclosure, as described above. The method may include agitating the fabric in the presence of water. The method may further comprise the step of carrying out a washing or cleaning operation. Water may be added before, during, or after the contacting step to form a treatment liquor.

The present disclosure also relates to a process for treating, for example by machine, a fabric, preferably soiled fabric, using a composition according to the present disclosure, comprising the steps of, placing a composition according to the present disclosure into contact with the fabric to be treated, and carrying out a treatment operation, such as a washing, cleaning, or fabric-enhancing operation. The contacting step may occur during the wash cycle or during the rinse cycle of an automatic washing machine.

Any suitable washing machine may be used, for example, a top-loading or front-loading automatic washing machine. Those skilled in the art will recognize suitable machines for the relevant treatment operation. The article of the present disclosure may be used in combination with other compositions, such as fabric additives, fabric softeners, rinse aids, and the like. Additionally, the detergent compositions of the present disclosure may be used in known hand washing methods.

The present disclosure may also be directed to a method of treating a fabric, the method comprising the steps of contacting a fabric with a detergent composition described herein, carrying out a washing step, and then contacting the fabric with a fabric softening composition. The entire method, or at least the washing step, may be carried out by hand, be machine-assisted, or occur in an automatic washing machine. The step of contacting the fabric with a fabric softening composition may occur in the presence of water, for example during a rinse cycle of an automatic washing machine.

The fabric to be treated may be a first fabric portion that is part of a laundry load, where the laundry load may comprise a second fabric portion. The second fabric portion may comprise a colorant, preferably a reactive dye or hydrolyzed product thereof. The first and second fabric portions may be part of the same article or garment. The first fabric portion may be part of a first article or garment, and the second fabric portion may be part of a second article or garment.

The processes of the present disclosure may include treating a multi-colored load of fabrics and/or garments. The processes of the present disclosure may include treating and/or contacting a first fabric portion and a second fabric portion with the same treatment liquor. The first fabric portion and the second fabric portion may be part of the same item or garment. The first fabric portion and the second fabric portion may be part of different items or garments. The first and second fabric portions may be of different colors. One of the first and second fabric portions may be light in color, while the other may be dark in color. One of the first and second fabric portions may be white, while the other may have a color. One of the first and second fabric portions may include a fabric substantive dye applied by the fabric or garment manufacturer, while the other may be undyed or substantially free of dye as provided by the fabric or garment manufacturer (e.g., substantially free of dye other than fugitive dyes from other portions or garments that have deposited onto the portion during previous wash or other treatment cycles). When on the same item or garment, the first portion may be adjacent to the second portion. The item or garment may comprise a multi-colored pattern, such as being striped, plaid, checked, or polka-dotted.

The first fabric portion may include a colorant. At least a portion of the colorant may be capable of escaping into the treatment liquor from the first fabric portion during a treatment process. The portion that escapes may be in terms of a certain percentage of the colorant that is initially present on the first fabric portion prior to the treatment process. The portion that escapes may be in terms of hydrolysis reaction products that are present after hydrolysis or other degradation of the colorant. The second fabric portion may be substantially free of the colorant, e.g., none of the colorant is intentionally applied to the second fabric portion by the manufacturer, and/or none is present other than any amount that have transferred during the present or previous treatment processes.

The colorant may be any colorant suitable for coloring a fabric or textile. The colorant may be a direct dye, a reactive dye, a disperse dye, an acid dye, a basic dye a vat or indigo dye, a sulfur dye, a derivative thereof, a hydrolyzed product thereof, or a combination thereof. It is believed that treatment composition that include the graft copolymer of the present disclosure are effective at inhibiting the transfer of colorants (such as dyes) from one portion of a fabric to another (dissimilarly colored) portion of the same fabric, or from one fabric to another fabric.

### Use of Polyester Copolymer and a Cellulase Enzyme

The present disclosure also relates to the use of a polyester copolymer and a cellulase enzyme according to the present disclosure as a dye transfer inhibitor in a fabric care composition, preferably where the dye is a particulate dye, more preferably indigo. Additionally or alternatively, the present disclosure further relates to a use of a polyester copolymer according to the present disclosure to inhibit discoloration and/or graying during treatment of a multi-colored fabric load.

The use of the polyester copolymer and cellulase enzyme may in a laundry treatment (e.g., a wash or rinse) operation, preferably wherein the copolymer is comprised within a wash liquor wherein the wash liquor is in contact with fabrics to be washed. The wash liquor may be prepared by diluting a fabric care composition, preferably a liquid laundry detergent composition, in water, preferably by between 300- and 800-fold, more preferably between 400- and 700-fold, wherein the fabric care composition comprises the graft co-polymer. The fabric care composition may comprise between 0.1% and 10%, preferably between 0.2% and 7%, more preferably between 0.5% and 5% even more preferably between 1% and 4%, most preferably between 1.25% and 3% by weight of the fabric care composition of the polyester copolymer. The fabric care composition may comprise between 0.0001% and 2%, or from about 0.001% to about 1%, or from about 0.002% to about 0.1%, or from about 0.005% to about 0.05%, by weight of the fabric care composition of the cellulase.

The fabric care composition may be in the form of a liquid composition, a granular composition, a single-compartment pouch, a multi-compartment pouch, a sheet, a pastille or bead, a fibrous article, a tablet, a bar, flake, or a mixture thereof. The fabric care composition may be a liquid composition, a granular composition, or a combination thereof. The fabric care composition may be comprised within a water-soluble unit dose article comprising a water-soluble film.

The fabrics to be treated during such use may be part of a laundry load. The load may include articles and/or garments. The load may comprise an article or garment that includes different colors (e.g., an article or garment comprises a first color and a second color), and/or the load may comprise articles or garments that are of different colors (e.g., a first article or garment comprises a first color, and a second article or garment comprises a second color that is different than the first color).

### Test Methods

### K-Value

K-value measures the relative viscosity of dilute polymer solutions and is a relative measure of the average molecular weight. As the average molecular weight of the polymer increases for a particular polymer, the K-value tends to also increase. The K-value is determined in a 3% by weight NaCl solution at 23° C. and a polymer concentration of 1% polymer according to the method of H. Fikentscher in Cellulosechemie, 1932, 13, 58.

Indigo Dye Transfer Fabric Treatment Method in a Mini-Washing Machine. New fabrics are pre-washed using one cycle in a WE front Loading washing machine such as Miele W1724 at 30° C. using 15 gpg water on the cotton short cycle, and pre-washed fabrics are treated with a detergent composition in the presence of dye bleeder fabrics using a Mini-washing Machine. The mini-washer is filled to a 5.7 L fill volume and is programmed for a 60 min wash cycle, and a 20 min rinse cycle with an agitation speed of 75 strokes per min using 15 gpg/50° C. (122° F.) water for the wash and 15 gpg/38° C. (100° F.) water for the rinse. The detergent composition (14.7 g for NA FL and 25.3 g for WE FL) is added to the washing pot after the water is filled, agitated for 30 s, then dye bleeder fabrics (7 pieces of 7.6 cm×cm×11.4 cm swatches of EMPA 277, ex test Fabrics, West Pittston, Pa.) are added to the machine and agitated for 60 s, and then pre-washed dye acceptor fabrics and ballast are added. The acceptor fabrics (120 g) are two, 100% cotton, Gildan, Toddler size 2T, white t-shirts, with test fabric swatches (9.5 cm×9.5 cm) sewn onto the shirt. Test fabrics include 100% cotton knit (#19502), and 98/2 cotton/spandex #19506 (available from WfK Testgewebe GmbH, Brüggen, Germany). Ballast fabrics (2× white 100% cotton, white Gildan t-shirts, Toddler size 2T and 1×50/50 cotton/polyester, white Gildan t-shirts Youth, size XS) are added for a total fabric weight of 400±15 g. Once the detergent, and all test fabrics are added to the mini-washer, the timed cycle begins. After the washing cycle is complete, the dye bleeder fabrics are removed, and the acceptor fabrics and ballast are dried in an automatic tumble dryer on low for 45 min (Kenmore dryer series), or until dry. The fabrics are washed for a total of three washing cycles, and then Test fabrics are de-linted using a lint roller to remove and fuzz that could interfere with the spectrophotometer measurement.

### Dye Transfer Measurement Method on Treated Fabrics

As used herein, the “L*C*h color space” and “L*a*b* color space” are three dimensional colorimetric models developed by Hunter Associates Laboratory and recommended by the Commission Internationale d'Eclairage (“CIE”) to measure the color or change in color of a dyed article. The CIE L*a*b* color space (“CIELAB”) has a scale with three-fold axes with the L axis representing the lightness of the color space (L*=0 for black, L*=100 for white), the a* axis representing color space from red to green (a*>0 for red, a*<0 for green) and the b* axis representing color space from yellow to blue (b*>0 for yellow, b*<0 for blue). The L*C*h color space is an approximately uniform scale with a polar color space. The CIE L*C*h color space (“CIELCh”) scale values are determined instrumentally and may also be calculated from the CIELAB scale values. Term definitions and equation derivations are available from Hunter Associates Laboratory, Inc. and from www.hunterlab.com, and are incorporated in their entirety by reference herein.

The amount of dye transfer onto the acceptor fabrics can be described, for example, in terms of the change in L*C*h before and after treatment of the fabric as measured via spectrophotometry (for example, via a Spectrophotomer CM-3610d, manufactured by Konica Minolta, Tokyo, Japan) and is reported as dE2000 value. As used herein, the dE2000 value includes the vector associated with the distance in the L*C*h space between the initial L*C*h value and the final L*C*h value and corrected for perception according to the procedure detailed in G. Sharma, et al, in “The CIE dE2000 Colour Difference Formula: Implementation Notes, Supplementary test Data and Mathematical Observations, Color Research and Application, Vol 30 (1), 2005, p 21-30. Test fabrics are are measured against the backing of the t-shirt. An average of two L*ab measures are taken per test fabric and two fabrics are measured per example.

### Sebum Stain Removal Method

Technical stain swatches of CW120 cotton containing PCS132 Discriminating Sebum and PCS 94 ASTM Dust Sebum (available from Accurate Product Development, Fairfield, Ohio), are treated with a detergent composition of the present invention using the normal wash setting on a NA high efficiency Whirlpool Duet 9200 washing machine. The machine uses a 19 L fill volume with 25° C. water for the wash and and 15° C. water rinse cycles. The wash and rinse cycles use 15 grain per gallon water. The detergent composition (49 g) is added to the washing machine drum after the water is filled at the beginning of the wash cycle, and then two, CW120 stain swatches plus 3.9 kg of de-sized fabric ballast are added to the drum. The de-sized ballast is comprised of approximately 50% by weight of 100% cotton T-shirts (Gildan T-shirts, TCS Apparel), 25% by weight of 50% polyester/50% cotton pillowcases (Standard Textile Company) and 25% by weight of 86% cotton/14% polyester terry towels (Standard Textile Company). A total of eight stain swatches are averaged from 2 internal replicates from 4 different wash cycles for a total of eight CW120 swatches. Treated fabrics are dried in a cotton/high setting in a Kenmore series dryer.

Standard colorimetric measurement was used to obtain L*, a* and b* values for each stain before and after the washing. From L*, a* and b* values, the stain level was calculated by comparing the initial stain level before washing to the stain level after washing and accounting for the initial background corresponding to an unstained portion of the fabric.

Stain removal from the swatches was measured as follows:

$$Stain Removal Index ( SRI ) = \frac{Δ {E}_{initial} - Δ {E}_{washed}}{Δ {E}_{initial}} \times 100$$

ΔEᵢₙᵢₜᵢₐₗ=Stain level before washing−Unstained, unwashed portion of fabric
ΔE_{washed}=Stain level after washing−Unstained, unwashed portion of fabric
   The SRI values are the averaged SRI values from the eight replicates. The stain level of the fabric before the washing (ΔEᵢₙᵢₜᵢₐₗ) is high; in the washing process, stains are removed and the stain level after washing is reduced (ΔE_{washed}). The better a stain has been removed, the lesser the value for ΔE_{washed} and the greater the difference between ΔEᵢₙᵢₜᵢₐₗ and ΔE_{washed} (ΔEᵢₙᵢₜᵢₐₗ−ΔE_{washed}). Therefore the value of the stain removal index increases with better washing performance.
   Dye Transfer Fabric Treatment Method in a Full-Scale Washing Machine Using Retail Clothes. White acceptor fabrics and a new yellow retail polo shirt are washed in a load containing new blue jeans to determine the difference in dye transfer with a composition of the invention under consumer relevant conditions. Fabrics are washed three times in a front loading washing machine such as North America Whirlpool Duet 9200 HE front-loading washing machine on the normal cycle using 7 gpg water at 32° C. water for the wash, and 15° C. water for the rinse. New blue jeans (2.9 kg) such as 2 pairs of Gap Perfect Boot, 99% cotton/1% Spandex; Old Navy Rock Star, 73% cotton/23% polyester; Gap 1969, 99% cotton/1% spandex, and Banana Republic Skinny Jeans, 90% Cotton, 7% polyester, 3% spandex are added to the drum. White acceptor fabrics (120 g) are two, 100% cotton, Gildan, Toddler size 2T, white t-shirts, with test fabric swatches (9.5 cm×9.5 cm) sewn onto the shirt. Test fabrics include 100% cotton knit (#19502), and 98/2 cotton/spandex #19506 (available from WfK Testgewebe GmbH, Brüggen, Germany). The yellow retail shirt is the Buttercream yellow polo shirt, 97% cotton, 3% spandex, available from Old Navy. White Ballast fabrics (white 100% cotton knit) are added for a total fabric weight of 3.6 kg. The detergent composition (49 g) is added using the dispenser. After the washing cycle is complete, the load is dried in an automatic tumble dryer on low for 45 min (Kenmore dryer series), or until dry. The fabrics are washed for a total of three washing cycles, and then Test fabrics are de-linted using a lint roller to remove any fuzz that could interfere with the spectrophotometer measurement.

### EXAMPLES

The examples provided below are intended to be illustrative in nature and are not intended to be limiting.

### EXAMPLES

### Example 1A. Synthesis Example of Copolymer 1A, X Includes a Hydroxyl Unit

Into a 2-liter 3-neck round bottom flask equipped with a magnetic stir bar, heating mantle, distillation head (with water cooled condenser, distillate receiving flask and nitrogen gas inlet) in one side neck, a thermometer in the other side neck and stopper in the center neck was added under nitrogen gas blanket 490.95 g (0.982 moles) of polyethylene glycol monomethyl ether having an average molecular weight of approx. 500 g/mole (available from Sigma-Aldrich), 297.00 g (1.53 moles) of dimethyl terephthalate, 84.80 g (0.921 moles) of glycerol, 111.00 g (1.07 moles) of neopentyl glycol, 0.77 g of 2,6-di-tert-butyl-p-cresol (BHT from TCI America), and 0.85 g of Titanium (IV) Isopropoxide.

The reaction mixture was heated with mixing under nitrogen atmosphere at 180-205° C. and the methanol thus produced was collected over 43 hours. Once most of the methanol quantity theoretically expected was collected, the reaction mixture was cooled, the distillation head replaced with a different distillation head with vacuum line. Vacuum was applied, and the mixture was heated to 230° C. As the polymer condensation continued, Neopentyl Glycol and Glycerol were removed from reaction mixture and collected as a distillate at 4-5 mm Hg pressure for 6 hours. The reaction progress was followed by Proton NMR, until about a 9:1 ratio of di-esterified Neopentyl Glycol to mono-esterified Neopentyl Glycol was reached, the reaction was discontinued and cooled to room temperature. The resulting product was a viscous, dark orange liquid.

### Example 1A-1. Synthesis Example of Copolymer 1A-1, X Includes an Amine Unit

The same procedure was followed as Example 1A using 490.95 g (0.982 moles) of polyethylene glycol monomethyl ether having an average molecular weight of approx. 500 g/mole (available from Sigma-Aldrich), 297.00 g (1.53 moles) of dimethyl terephthalate, 111.60 g (0.921 moles) of tris(hydroxymethyl)aminomethane, 111.00 g (1.07 moles) of neopentyl glycol, 0.77 g of 2,6-di-tert-butyl-p-cresol (BHT from TCI America), and 0.85 g of Titanium (IV) Isopropoxide. The resulting product was a viscous, dark brown liquid.

### Example 1B. Suspension Graft Copolymer Examples

The following table, Table 1, shows illustrative, non-limiting examples of graft copolymers according to the present disclosure; see examples 1B-1 to 1B-3.

TABLE 1

| Graft | | | | | | |
|---|---|---|---|---|---|---|
| Copolymer | Monomer Ratio (by wt) | | | PEG Molecular | | VAc |
| Examples | PEG | VP | VAc | Weight (Da) | K-Value | Hydrolysis |
| 1B-1 | 1.00 | none | 1.5 | 6000 | * | <20% |
| 1B-2 | 1.00 | 0.40 | 0.60 | 6000 | 23.5 | <20% |
| 1B-3 | 1.00 | 0.40 | 0.60 | 6000 | 24.5 | 40% |

PEG = poly(ethylene glycol);
VP = vinyl pyrrolidone;
VAc = vinyl acetate

Synthesis Graft Copolymer 1B-1 is described in WO 01/05874 and is available from BASF (Ludwigshafen, Germany).

### Synthesis Example of Graft Copolymer 1B-2 and 1B-3

A polymerization vessel equipped with stirrer and reflux condenser is initially charged with 720 g of PEG (4000 g/mol) and 60 g ethyl acetate under nitrogen atmosphere. The mixture is homogenized at 70° C.

Then, 432 g of vinyl acetate (in 2 h), 288 g of vinylpyrrolidone in 576 g of ethyl acetate (in 5 h), and 30.2 g of tert.-butyl perpivalate in 196.6 g ethyl acetate (in 5.5 h) are metered in. Upon complete addition of the feeds, the solution is stirred at 70° C. for 1 h. Subsequently, 3.8 g tert-butyl perpivalate in 25.0 g ethyl acetate (in 1.5 h) were metered in followed by 0.5 h of stirring.

The volatiles are removed by vacuum stripping. Then, 676.8 g deionized water are added and a steam distillation is conducted at 100° C. for 1 h resulting in polymer 1B-2.

To hydrolyze polymer 1B-2 to polymer 1B-3, the temperature of the reaction mixture is reduced to 80° C. and 160.6 g of a 50% w/w aqueous sodium hydroxide solution is added to hydrolyze to 40 mol % of the vinyl acetate monomer units. Upon complete addition of the sodium hydroxide solution, the mixture is stirred for 1 h at 80° C. and subsequently cooled to ambient temperature.

The resulting graft polymers are characterized by a K-value listed in Table 1. The solid content of the final solution is from 45% to 55%.

### Examples 1C-1E. Less Dye Transfer After 3 Wash Cycles with Copolymer and XYG and Graft Copolymer 1B-3 in Detergent 2G in Loads Containing New Retail Items

The combination of 1.9% copolymer Example 1A, 0.01% cellulase enzyme XYG and the 2.7% of graft copolymer 1B-3 decreases dye transfer on the yellow cotton/spandex retail shirt after washing 3 times using the Dye Transfer Fabric Treatment Method in a Full-Scale Washing Machine Using Retail Clothes. Table 10 shows that Example 1C, a typical liquid detergent without any graft copolymer or polyester copolymer, or cellulase enzymes has a dE2000 of 6.3 after 3 wash cycles and has the most dye transfer on the yellow shirt. Example 1D shows that dye transfer can be reduced by 0.9 units by adding the suspension graft copolymer 1B-3 and 0.01% XYG however the combination of 1.8% copolymer with XYG and the suspension graft copolymer 1B-3 further decreases dye transfer by 1.6 units on cotton/spandex test fabrics. The fabric treated with 1E has noticeably less dye transfer than 1D in visual assessment.

| | | | | | Retail Yellow | | |
|---|---|---|---|---|---|---|---|
| | | | | | Cotton/spandex | | |
| | | 2.7% Graft | | | | Delta vs | |
| Example | Detergent | Copolymer^{a} | Co-Polymer^{b} | XYG^{c} | dE2000 | REF | Appearance |
| 1C | 2H | none | none | none | 6.3 | REF | Most dye |
| | | | | | | | transfer |
| 1D | 2G | 1B-3 | none | 0.01% | 5.4 | −0.9 | Less Dye |
| | | | | | | | Transfer |
| | | | | | | | than 1C |
| 1E | 2G | 1B-3 | 1.9% | 0.01% | 4.7 | −1.6 | Least dye |
| | | | | | | | transfer |

^{a}Described in U.S. Pat. No. 8,143,209 and available from BASF (Ludwigshafen, Germany) or Synthesis Example 1B;
^{b}copolymer described in Example 1A;
^{c}Xyloglucancase (XYG) available under the tradename Whitezyme from Novozymes, Copenhagen, Denmark.

### Example 2. Liquid or Gel Detergents

Table 2 shows illustrative liquid or gel detergent fabric care compositions that may be prepared by mixing the ingredients listed in the proportions shown below. Copolymer, and cellulase enzymes, xyloglucanase and endolase, are added as described in the specific examples below.

TABLE 2

| Ingredient (wt %) | 2A | 2B | 2C | 2D | 2E | 2F | 2G | 2H | 2I | 2J |
|---|---|---|---|---|---|---|---|---|---|---|
| C₁₂-C₁₅ alkyl polyethoxylate | 5.5 | 3.0 | 3.0 | 3.0 | 4.5 | 4.5 | 5.5 | 10.4 | 13.4 | 6.0 |
| (3.0 or 1.8) sulfate¹ | | | | | | | | | | |
| C_{11.8} linear alkylbenzene | 12.5 | 7.4 | 7.4 | 7.4 | 10.4 | 10.4 | 12.5 | 6.8 | 8.0 | 2.1 |
| sulfonic acid² | | | | | | | | | | |
| C14-C15 alkyl 7-ethoxylate | 5.2 | 2.9 | 2.9 | 2.9 | 4.4 | 4.4 | 5.2 | 4.7 | 2.8 | 4.0 |
| or C₁₁-C₁₄ alkyl 7-ethoxylate | | | | | | | | | | |
| or C14-C15 alkyl 9-ethoxylate | | | | | | | | | | |
| or mixtures¹ | | | | | | | | | | |
| C₁₂-C₁₄ amine oxide | 0.5 | 0.4 | 0.4 | 0.4 | 0.4 | 0.4 | 0.5 | 0.7 | 1.4 | 0.5 |
| C₁₂-C₁₈ Fatty Acid⁴ | 0.9 | 2.6 | 1.3 | 2.6 | 2.0 | 4.6 | 0.9 | 0.9 | 3.6 | — |
| Solvents (1,2-Propane | 6.3 | 1.7 | 0.9 | 1.8 | 1.2 | 1.9 | 7.0 | 5.1 | 5.2 | 2.9 |
| diol, Ethanol, Diethylene | | | | | | | | | | |
| glycol, Glycerol) | | | | | | | | | | |
| Na Cumene Sulfonate | — | 1.3 | 1.3 | 1.3 | 2 | 2 | — | 0.15 | 2 | — |
| Citric acid | 2 | 2.8 | 2.8 | 2.8 | 2.9 | 2.6 | 2 | 1.1 | 4.4 | 1 |
| Enzymes (mixtures of | 0.09 | 0.004 | 0.034 | 0.004 | 0.268 | 0.071 | 0.09 | 0.078 | 0.11 | 0.046 |
| protease⁶ and (amylase, | | | | | | | | | | |
| lipase, pectawash, | | | | | | | | | | |
| mannanase)⁷ | | | | | | | | | | |
| Cellulase Enzymes⁷, if any, | From 0% to 0.5% further described in the examples below | | | | | | | | | |
| according to the present | | | | | | | | | | |
| invention | | | | | | | | | | |
| Fluorescent Whitening | — | — | — | — | — | — | 0.18 | 0.15 | 0.14 | — |
| Agent⁸ | | | | | | | | | | |
| Copolymer, if any, | From 0% to 5% further described in the examples below | | | | | | | | | |
| according to the present | | | | | | | | | | |
| invention | | | | | | | | | | |
| Cleaning Polymer^{10, 11} | — | — | — | — | — | — | 1.5 | 2.6 | 2.8 | 0.3 |
| Zwitterionic ethoxylated | 0.9 | 0.5 | 0.51 | 0.5 | 0.8 | 0.8 | — | — | — | — |
| quaternized sulfated | | | | | | | | | | |
| hexamethylene diamine¹² | | | | | | | | | | |
| Graft copolymer¹³ | — | 1.8 | 0.6 | — | 0.6 | 1.8 | — | — | — | — |
| Hydrogenated castor oil¹⁴ | — | 0.3 | 0.3 | 0.3 | — | — | 0.1 | 0.1 | 0.1 | — |
| Water, solvents, chelants, | to | to | to | to | to | to | to | to | to | to |
| perfumes, encapsulated | 100%; pH | 100%; pH | 100%; pH | 100%; pH | 100%; pH | 100%; pH | 100 %; pH | 100%; pH | 100%; pH | 100%; pH |
| perfume, brightener, dyes, | 7.0-8.5 | 7.0-8.5 | 7.0-8.5 | 7.0-8.5 | 7.0-8.5 | 7.0-8.5 | 7.0-8.5 | 7.0-8.5 | 7.0-8.5 | 7.0-8.5 |
| hue dye, buffers, | | | | | | | | | | |
| neutralizers, stabilizers, | | | | | | | | | | |
| enzymes and other optional | | | | | | | | | | |
| components | | | | | | | | | | |

¹Available from Shell Chemicals, Houston, TX.
²Available from Huntsman Chemicals, Salt Lake City, UT.
³ Available from Sasol Chemicals, Johannesburg, South Africa
⁴ Available from The Procter & Gamble Company, Cincinnati, OH.
⁵ Available from Sigma Aldrich chemicals, Milwaukee, WI
⁶Available from DuPont-Genencor, Palo Alto, CA.
⁷Available from Novozymes, Copenhagen, Denmark
⁸Available from Ciba Specialty Chemicals, High Point, NC
⁹ Available from Milliken Chemical, Spartanburg, SC
¹⁰600 g/mol molecular weight polyethylenimine core with 20 ethoxylate groups per —NH and available from BASF (Ludwigshafen, Germany)
¹¹600 g/mol molecular weight polyethylenimine core with 24 ethoxylate groups per —NH and 16 propoxylate groups per —NH. Available from BASF (Ludwigshafen, Germany)
¹²Described in WO 01/05874 and available from BASF (Ludwigshafen, Germany)
¹³Described in U.S. Pat. No. 8,143,209 and available from BASF (Ludwigshafen, Germany) or as described in Example 1B in the specification herein.
¹⁴Available under the tradename ThixinR from Elementis Specialties, Highstown, NJ

### Example 3. Liquid Detergents in the Form of Soluble Mono- or Multi-Compartment Unit Dose

The following compositions were prepared by mixing of the individual components in the proportions shown below, followed by enclosing in a water soluble poly(vinyl alcohol) film supplied by the Monosol company, to obtain water soluble unit dose laundry pouches. Each unit dose laundry pouch comprised 29.9 g of the detergent compositions. Copolymer, and cellulase enzymes, xyloglucanase and endolase, are added as described in the specific examples below.

TABLE 3

| Ingredient (wt %) | 3A | 3B | 3C | 3D | 3E |
|---|---|---|---|---|---|
| C₁₂-C₁₅ | 15.5 | 8.8 | 9.5 | 13.7 | 10.3 |
| alkyl polyethoxylate | | | | | |
| (3.0) sulfate¹ | | | | | |
| C_{11.8} linear | 22.8 | 18.6 | 20.1 | 13.7 | 20.9 |
| alkylbenzene | | | | | |
| sulfonic acid² | | | | | |
| C₁₄-C₁₅ | 3.9 | 14.5 | 17.1 | 14.5 | 9.8 |
| alkyl 7-ethoxylate¹ | | | | | |
| or C₁₂-C₁₄ alkyl | | | | | |
| 7-ethoxylate³ | | | | | |
| (or mixtures thereof) | | | | | |
| 1,2 Propane diol⁵ | 11.9 | 15.0 | 15.7 | 15.7 | 15.7 |
| Glycerol | 4.0 | 5.0 | 5.4 | 4.9 | 4.0 |
| Di propylene Glycol | 4.2 | 4.2 | 0.5 | 4.2 | 4.2 |
| C₁₂-C₁₈ | 6.3 | 6.1 | 6.5 | 6.1 | 6.1 |
| Fatty Acid⁴ | | | | | |
| Citric acid | 0.9 | 0.9 | 0.9 | 0.9 | 0.9 |
| Enzymes (mixtures of | 0.1 | 0.1 | 0.05 | 0.05 | 0.1 |
| Protease⁶ and | | | | | |
| (amylase, lipase, | | | | | |
| mannanase, | | | | | |
| xyloglucanase)⁷ | | | | | |
| Cellulase Enzymes⁷, | From 0% to 0.5% further described in the examples below | | | | |
| if any, according to the | | | | | |
| present invention | | | | | |
| Fluorescent Whitening | 0.2 | 0.2 | 0.2 | 0.2 | 0.32 |
| Agent⁸ | | | | | |
| Hueing Agent | 0.03 | 0.03 | 0.03 | 0.0 | 0.03 |
| Chelant | 0.9 | 2.1 | 0.9 | 0.9 | 0.9 |
| Copolymer, | From 0 to 5% | | | | |
| if any, of the | | | | | |
| present invention | | | | | |
| Cleaning Polymers^{10, 11} | 3.4 | 2.5 | 6.4 | 3.2 | 3.4 |
| Graft Copolymer¹² | 2.3 | 2.3 | 2.3 | 2.3 | 2.3 |
| Hydrogenated | 0.1 | 0.13 | 0.15 | 0.15 | 0.15 |
| castor oil¹³ | | | | | |
| Water, perfumes, dyes, | to 100% | to 100% | to 100% | to 100% | to 100% |
| buffers, neutralizers, | pH | pH | pH | pH | pH |
| stabilizers and other | 7.0-8.5 | 7.0-8.5 | 7.0-8.5 | 7.0-8.5 | 7.0-8.5 |
| optional components | | | | | |

¹Available from Shell Chemicals, Houston, TX.
²Available from Huntsman Chemicals, Salt Lake City, UT.
³Available from Sasol Chemicals, Johannesburg, South Africa
⁴Available from The Procter & Gamble Company, Cincinnati, OH.
⁵Available from Sigma Aldrich chemicals, Milwaukee, WI
⁶Available from DuPont-Genencor, Palo Alto, CA.
⁷Available from Novozymes, Copenhagen, Denmark
⁸Available from Ciba Specialty Chemicals, High Point, NC
⁹Available from Milliken Chemical, Spartanburg, SC
¹⁰600 g/mol molecular weight polyethylenimine core with 20 ethoxylate groups per —NH and available from BASF (Ludwigshafen, Germany)
¹¹600 g/mol molecular weight polyethylenimine core with 24 ethoxylate groups and 16 propoxylate groups per —NH. Available from BASF (Ludwigshafen, Germany)
¹²Described in U.S. Pat No. 8,143,209 and available from BASF (Ludwigshafen, Germany) or as described in Example 1B in the specification herein.
¹³Available under the tradename ThixinR from Elementis Specialties, Highstown, NJ

### Example 4. Less Indigo Transfer with Copolymer 1A and Cellulase Enzymes in Detergent 2A

The combination of Copolymer 1A and cellulase enzymes, xyloglucanase (Whitezyme® ex Novozymes) and endolase (Celluclean 50001, ex Novozymes), decrease Indigo dye transfer as shown by a decrease in dE2000 on cotton/spandex white fabrics after washing 3 times using the Indigo Dye Transfer Fabric Treatment Method with NA FL concentration. The amount of dye transfer on washed fabrics is measured using a spectrophotometer and described as a change in dE2000 where a higher number corresponds to more dye on fabric. As can be seen from Table 4, Copolymer 1A (Example 4B) decreases the indigo dye transfer on cotton/spandex by a dE2000 difference of about 1 as compared to 4A, the chassis alone, where the difference between the reference 4A and 4B is described as ddE2000 in Table 4. The combination of copolymer 1A and XYG (Example 4C) or 1A and endolase (Example 4D) results in an equivalent dE2000 to the copolymer 1A only. Surprisingly, the combination of cellulase enzymes XYG and endolase with copolymer 1A results in less dye transfer with a ddE2000 of 1.7 versus the detergent control 4A that is noticeably lighter.

TABLE 4

| | | | dE2000 | | |
|---|---|---|---|---|---|
| | Copolymer | | (Cotton/ | | |
| Example | 1A^{a} | Cellulase | spandex) | ddE2000 | Appearance |
| 4A | none | none | 4.4 ± 0.2 | REF | Most dye transfer |
| | | | | | (darkest) |
| 4B | 3.9% | none | 3.3 ± 0.2 | 1.1 | Less dye transfer than 1A |
| 4C | 3.9% | XYG^{b} | 3.4 ± 0.1 | 1.0 | Same as 1B and 1D |
| 4D | 3.9% | Endolase^{c} | 3.5 ± 0.1 | 0.9 | Same as 1B and 1C |
| 4E | 3.9% | XYG^{a} + | 2.7 ± 0.1 | 1.7 | Least Dye Transfer |
| | | endolase^{b} | | | (lightest) |

^{a}copolymer 1A made according the the synthesis in Synthesis Example 1;
^{b}Xyloglucanase (XYG) available under the tradename Whitezyme from Novozymes, Copenhagen, Denmark is added to 2A at 0.02%;
^{c}Endolase available under the tradename Celluclean 5000l from Novozymes, Copenhagen, Denmark is added to 2A at 0.008%.

### Example 7. Less Indigo Dye Transfer on Poly/Cotton and Cotton/Spandex Fabrics Washed with Copolymer and Xyloglucanase in Detergent 2B

The combination of 0.8% copolymer with 0.01% XYG and the graft copolymer 1B-1 in detergent 2B decreases Indigo dye transfer on retail poly/cotton knit and cotton/spandex test fabrics after washing 3 times using the Indigo Dye Transfer Fabric Treatment Method with WE FL concentration. As shown in Table 7, the detergent composition 2B containing no copolymer or no XYG has the highest amount of dye transfer on the retail poly/cotton knit and the cotton/spandex test fabric with a dE2000 of 6.8 and 4.4, respectively. The combination of the copolymer and XYG noticeably reduces dye transfer on both fabrics where the dye transfer reduction is higher, and visually noticeable on the poly/cotton blend with a ddE2000 of 2.7-4.1 for Examples 7B-7C as shown in Table 7 below. There is also a visibly noticeable reduction on the cotton/spandex fabric with a ddE2000 of 1.2-1.8 for Example 7B-7D.

TABLE 7

| | | | Poly/Cotton Knit^{e} | | Cotton/spandex | | |
|---|---|---|---|---|---|---|---|
| | 0.8% | | | Delta | | Delta | |
| Example | Copolymer | Cellulase ^{d} | dE2000 | vs REF | dE2000 | vs. REF | Appearance |
| 7A | none | none | 6.8 ± 0.4 | REF | 4.2 ± 0.2 | REF | Most dye |
| | | | | | | | transfer |
| 7C | Linear^{b} | 0.01% | 3.3 ± 0.1 | 3.4 | 2.6 ± 0.1 | 1.6 | Even less |
| | | | | | | | dye transfer |

^{b}Branched PET-PEG made;
^{d} Xyloglucancase (XYG) available under the tradename Whitezyme from Novozymes, Copenhagen, Denmark;
^{e}Croft & Barrow, striped poly/cotton knit retail shirt purchased from Kohls Department store.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising a surfactant system, a non-ionic polyester copolymer, a cellulase enzyme, and from about 0.1% to about 15% by weight of the composition of a suspension graft copolymer comprising poly(vinylpyrrolidone)-poly(vinyl acetate)-g-poly(ethylene glycol);
wherein the detergent composition comprises from about 10% to about 50%, by weight of the detergent composition, of the surfactant system,
wherein the surfactant system comprises anionic surfactant and nonionic,
wherein the detergent composition comprises from about 0.1% to about 5%, by weight of the detergent composition, of the non-ionic polyester copolymer,
wherein the copolymer comprises polyethylene glycol units and terephthalate units.

2. The detergent composition of claim 1, wherein the copolymer comprises a structure as defined by the combination of structural units (I), (II), (III), a combination of one or more of (II) and (III), a combination of one or more of (I), (II), and (III), a combination of one or more of (I) and (II), or a plurality of any of (I), (II), or (III):
—[(OCHR¹—CHR²)ₐ—O—OC—Ar—CO—]_{d} (I)
—[(OCHR³—X—CHR⁴)_{b}—O—OC—Ar—CO—]ₑ (II)
—[(OCHR⁵—CHR⁶)_{c}—OR⁷]_{f} (III)
wherein:
a, b and c are from 0 to 200;
d, e and f are from 1 to 50;
Ar is a 1,4-substituted phenylene;
X is a bifunctional group containing at least one carbon atom and at least one hydroxyl unit or amine unit;
R¹, R², R³, R⁴, R⁵ and R⁶ are independently selected from H or C₁-C₁₈ n- or iso-alkyl; and
R⁷ is independently selected from H or a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

3. The detergent composition of claim 1, wherein the suspension graft copolymer polyester has a number average molecular weight in the range of 700 to 50000.

4. The detergent composition according to claim 1, wherein the suspension graft copolymer further comprises poly(vinylacetate)-g-poly(ethylene glycol).

5. The detergent composition according to claim 1, wherein the suspension graft copolymer comprises between 0 and 60% hydrolysis of the vinyl acetate units.

6. The detergent composition of claim 1, wherein the detergent composition comprises from about 0.0001% to about 0.1% by weight of the cellulase enzyme.

7. The detergent composition of claim 1, wherein the composition further comprises xyloglucanase enzyme.

8. The detergent composition of claim 1, wherein the copolymer is defined by the combination of structural units (I) and (III):
—[(OCHR¹—CHR²)ₐ—O—OC—Ar—CO—]_{d} (I)
—[(OCHR⁵—CHR⁶)_{c}—OR⁷]_{f} (III)
wherein:
a and c are from 1 to 200;
d and f are from 1 to 50;
Ar is a 1,4-substituted phenylene;
R¹, R², R³, R⁴, R⁵ and R⁶ are independently selected from H or C₁-C₁₈ n- or iso-alkyl; and
R⁷ is independently selected from H or a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

9. The detergent composition of claim 8, wherein the copolymer has a number average molecular weight in the range of 700 to 50000 g/mol.

10. The detergent composition of claim 8, wherein:
R¹, R², R⁵ and R⁶ independently are H or methyl,
R⁷ is independently H or methyl,
a is a number from 1 to 20 and c is a number from 1 to 50,
d is a number from 1 to 25, and
f is a number from 1 to 2.

11. The detergent composition of claim 2, wherein the copolymer comprises the structural unit (II) wherein X is an amine unit.

12. The detergent composition of claim 1, wherein the detergent composition consists of a liquid composition, a portion of a unit dose detergent, a solid form detergent, or a combination thereof.

13. A process of laundering fabrics utilizing the detergent composition of claim 1, the process comprising contacting one or more fabrics with the detergent composition.

14. A detergent composition comprising:
i) from about 10% to about 50%, by weight of the composition, of a surfactant system comprising an anionic surfactant and a nonionic surfactant,
ii) from about 0.1% to about 5%, by weight of the composition of a non-ionic polyester copolymer comprising the following structure —[(OCHR³—X—CHR⁴)_{b}—O—OC—Ar—CO—]ₑ, wherein b is from 1-200, e is from 1 to 50, R³ and R⁴ are independently selected from H or C₁-C₁₈ n- or iso-alkyl, Ar is a 1,4-substituted phenylene, and X is a bifunctional group containing at least one carbon atom and at least one hydroxyl unit or amine unit; and
iii) a cellulase enzyme.

15. The detergent composition of claim 14, wherein the copolymer comprises polyethylene glycol units and terephthalate units.

16. The detergent composition of claim 15, wherein the copolymer comprises a structure as defined by the combination of structural units (I), (II), and (III); a combination of (II) and (III), or a combination of (I) and (II):
—[(OCHR¹—CHR²)ₐ—O—OC—Ar—CO—]_{d} (I)
—[(OCHR³—X—CHR⁴)_{b}—O—OC—Ar—CO—]ₑ (II)
—[(OCHR⁵—CHR⁶)_{c}—OR⁷]_{f} (III)
wherein:
a, b, and c are from 1 to 200;
d, e, and f are from 1 to 50;
Ar is a 1,4-substituted phenylene;
X is a bifunctional group containing at least one carbon atom and, at least one hydroxyl unit or amine unit;
R¹, R², R³, R⁴, R⁵ and R⁶ are independently selected from H or C₁-C₁₈ n- or iso-alkyl; and
R⁷ is independently selected from H or a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

17. The detergent composition of claim 15, wherein the non-ionic polyester copolymer has a number average molecular weight in the range of 700 to 50000 g/mol.

18. The detergent composition of claim 15, wherein the composition further comprises a suspension graft copolymer, wherein the suspension graft copolymer is present at a level from about 0.1% to about 15% by weight of the composition.

19. The detergent composition according to claim 18, wherein the suspension graft copolymer is selected from the group consisting of poly(vinylacetate)-g-poly(ethylene glycol), poly(vinylpyrrolidone)-poly(vinyl acetate)-g-poly(ethylene glycol), and combinations thereof.

20. The detergent composition of claim 15, wherein X comprises at least one hydroxyl unit.
